(19) United States
(12) Patent Application Publication
(10) Pub. No.: US 2009/0234720 A1
(43) Pub. Date: Sep. 17, 2009

(54) Method and System for Tracking and Coaching Service Professionals

(75) Inventors: Sam O. George, Aliso Viejo, CA (US); Julee Frank, Long Beach, CA (US)

Correspondence Address: The Marbury Law Group, PLLC, 11800 Sunrise Valley Drive, Suite 1000, Reston, VA, 20191, US

(73) Assignee: GRIDBYTE, Aliso Viejo, CA (US)

(21) Appl. No.: 12/143,516

(22) Filed: Jun. 20, 2008

Related U.S. Application Data
(60) Provisional application No. 61/036,932, filed on Mar. 15, 2008.

(51) Int. Cl. G06F 11/34

(52) U.S. Cl. 705/11

(57) ABSTRACT

A method and system for tracking and managing a service professional's business includes a server coupled to the Internet for receiving business parameter data from a service professional on a remote computer. Business parameter data includes a variety of data of relevance to the service professional's particular type of business. Current and historical business parameter data are subjected to a multivariate regression analysis to determine a business model equation's coefficients which may be linear or polynomial. Current week business parameter data can be applied to the business model to determine whether the business is operating within the business model or is achieving performance goals. The business model equation can be used to suggest measures to improve business performance. Coefficients of other service professional business models may be mined to provide peer comparisons. Analysis results can be used to generate coaching suggestions which the server can deliver to the service professional.

### RELATED APPLICATIONS

The present application claims the benefit of priority to U.S. Provisional Patent Application No. 61/036,932 filed Mar. 15, 2008 entitled “Method and System for Tracking Service Professionals,” the entire contents of which are hereby incorporated by reference.

### FIELD OF INVENTION

This invention generally relates to methods and systems for business management, and more particularly to methods and systems for tracking and coaching hair salon professionals.

### BACKGROUND

Service professionals, such as hair stylists and hair salon professionals, typically operate as independent contractors rather than as employees of businesses where they work. (The system is now fully applicable to commission stylists and may be used by Salons and Salon-chains to develop stylists). Consequently, service professionals are often individual small businesses operating within other small businesses. To manage their business, service professionals currently must use paper-journal systems with ad-hoc human-coaching tools which are generally cumbersome and inefficient. Such paper systems are error prone and expensive, and fail to provide users with business-planning or in-depth business-coaching tools to aid them in their tracking and growing their business. Paper-journal systems provide no benchmarking capabilities to allow service professionals to compare themselves to others in the industry. Paper-journal systems do not enable service professionals to evaluate alternative business performance options or estimate the impact of changes that occur in their business as it grows. Paper-journal systems also provide little in the way of retirement planning, goal setting and self tracking tools. Thus, a segment of the small business community is without basic analytical tools for managing and evaluating their business.

### SUMMARY

The various embodiments provide methods and systems for tracking and managing a service professional's business, such as the business of a hair stylist operating as an independent contractor. The various embodiments may be implemented on a server coupled to the Internet for receiving business parameter data from service professionals accessing the server via the Internet from a remote computer. Business parameter data includes a variety of data of relevance to the service professional's particular type of business. Current and historical business parameter data can be analyzed using a multivariate regression analysis to generate a business model equation which may be linear, periodic (e.g., sinusoidal) or polynomial. The various embodiments build a business-model based on current year data using current year data and/or prior year data as a basis. If there are significant differences between current year data and a baseline model based on prior year data, the embodiment methods construct a new business model. Constructing a business model is based on the individuality of the service professional's data (current year and/or prior year). The resulting business model can be used to project future business performance and assess whether the business is operating within the business model or is achieving performance goals. The business model can be used to set next week (or other time period) goals and suggest measures to improve business performance. A cohort business model may be generated based on business parameter data of other service professional business models and used as a comparison. Each business model can be classified relative to others in unique cohorts. The cohort data can provide additional optimization parameters for refining the business model. Comparisons to prior year performance may also be made. Analysis results can be used to generate coaching suggestions which the server can deliver to the service professional.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a component block diagram of a server suitable for use with the various embodiments.

FIG. 2 illustrates a network diagram of a communication network suitable for use with the various embodiments.

FIG. 3 illustrates a process flow diagram of process steps that may be implemented in an embodiment.

FIG. 4 illustrates a message flow diagram associated with the process steps illustrated in FIG. 3.

FIG. 5 is an information flow diagram illustrating information communications among various modules and webpages of an embodiment.

FIG. 6 is a process flow diagram of processing steps for analyzing business parameter data according to an embodiment.

FIGS. 7A-C is a process flow diagram of processing steps for analyzing business parameter data to generate a business model according to an embodiment

FIGS. 8A-B illustrate the “Weekly Entry One” webpage presenting a primary user interface according to an embodiment.

FIG. 9 illustrates the “Weekly Entry Two” webpage presenting another primary user interface according to an embodiment.

FIGS. 10A-E illustrate the “How Am I Doing” webpage presenting data analysis results according to an embodiment.

FIG. 11 illustrates the “Planning” webpage for receiving data inputs and presenting data analysis results according to an embodiment.

FIGS. 12 illustrate the “About RSSS” webpage for explaining the RSSS week concept to a user according to an embodiment.

FIGS. 13A-I illustrate the “Help” webpage according to an embodiment.

FIG. 14 illustrates the “Your Account” webpage according to an embodiment.

FIGS. 15 illustrate the “Customer Service” webpage according to an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In this description, the term “exemplary” is used herein to mean “serving as an example, instance, or illustration.” Any implementation described herein as “exemplary” is not necessarily to be construed as preferred or advantageous over other implementations.

The various embodiments implement an electronic business journal system by which business professionals, particularly service professionals, can track and optimize their business growth in terms of clients, services and revenue while minimizing expenses and hours-worked. The embodiment methods and systems are designed for business professionals, individual contractors and services professionals, such as hair salon professionals who operate as independent contractors.

The various embodiments employ unique methods and systems to directly track business performance of service professionals and provide them with coaching to improve their overall business performance and growth. In providing tracking and coaching to business professionals, the embodiment methods and systems apply a Shooting algorithm to provide longitudinal forecasting and calculate data in real-time. The Shooting algorithm projects future performance of the business based upon the current “trajectory” of the business based upon recent trends within a plurality of business parameter values measured against time (e.g., date of data entry). In conducting these calculations the system is capable of extending its analysis and learning algorithms to all available data, including those from previous years.

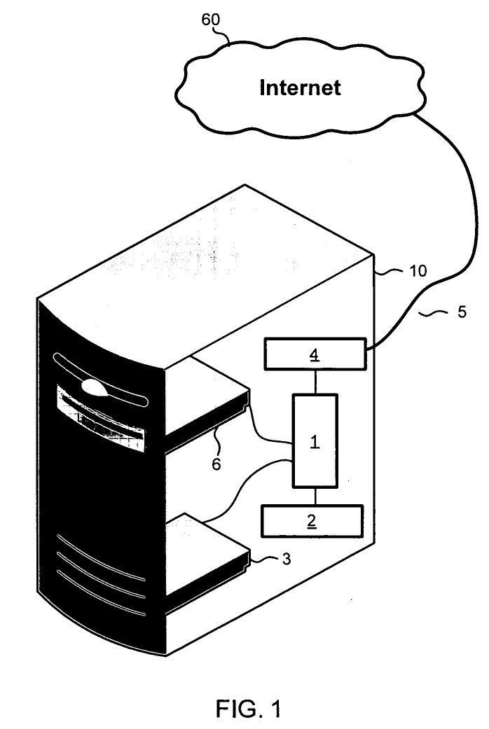

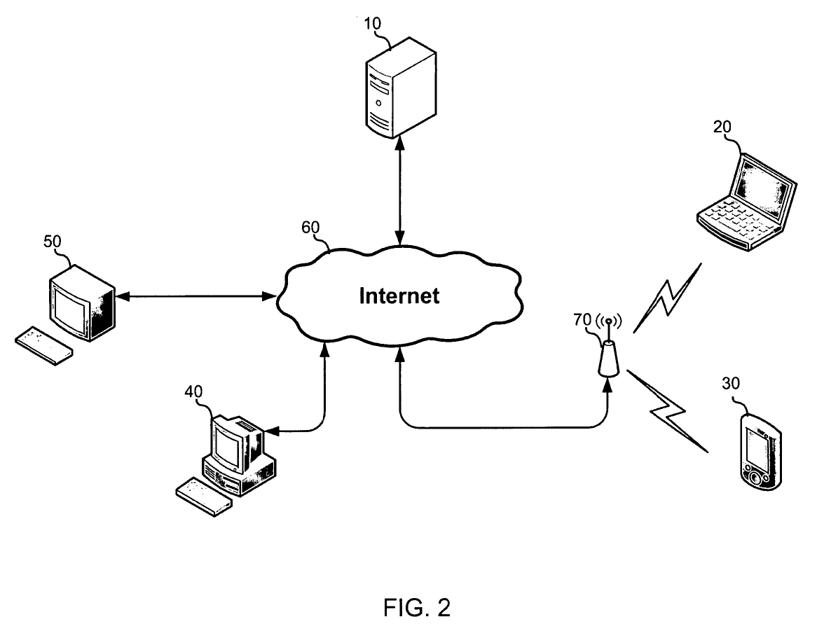

The embodiments described herein may be implemented on any of a variety of server systems such as illustrated in FIG. 1. Servers 10 typically include a processor 1 coupled to volatile memory 2 and a large capacity nonvolatile memory, such as a disk drive 3. The processor 1 is coupled to one or more network interface circuits, such as high speed modems 4 coupled to a network 5 such as the Internet 60. A server 10 may also include a portable media reader, such as a compact disc (CD) drive 6 coupled to the processor 1.

In the various embodiments, a server 10 may be configured by executing server-executable software to receive inputs from and provide analysis and information to service professionals which enable them to track their business performance and receive business coaching. The server 10 may be configured by software to provide users with a forecasting and/or “what-if” tool to analyze future growth possibilities. The methods and systems of the various embodiments take the guess-work out of forecasting and tracking a business, provide users with easy to access information that will help them manage their businesses effectively. Such tools may allow users to easily generate and view reports such as “How Am I Doing” or “When can I raise prices.” The software used to configure the server 10 may be provided as a software-as-a-service (SaaS) e-commerce business system, hosted intranet application, and software application.

Users can access the server 10 though many different means. As illustrated in FIG. 2, users may access the server 10 through the Internet 60 and by employing any device capable of connecting to the Internet 60. For instance, users may access the server 10 using workstations 50 or personal computers (PC) 40 that are directly connected to the Internet 60 through wired connections. Users may also access the server 10 using wireless connections by, for example, using mobile devices 30 or laptop computers 20 wirelessly connect to a wireless access point 70 which is connected to the Internet 60.

Because the data transmitted over the Internet 60 includes information that may be confidential to the business owner, the data communicated from and to the server 10 may be encrypted. Methods used for encrypting data that can be communicated from and to a server are well known in the art and may be employed in the methods and systems of the various embodiments.

The server 10 may be configured to function in many ways. For example, it can be configured to function as a self-hosted SaaS product with a public facing portal, such as a website hosted by a managing company though which users may communicate with the server 10. The server 10 may also be configured to integrate into intranets of corporations who may implement self-branded features.

In addition to providing the functional tools described herein, the server 10 may maintain a database of user accounts in which individual service professionals can store their personal and business information. User accounts can be stored in any of a variety of known database structures languages, such as the Structure Query Language (SQL) database computer language, to enable users and server application tools to retrieve, analyze, update and delete user data and analysis results. The server 10 may also include databases of industry-wide information drawn from external sources as well as sanitized information mined from user accounts.

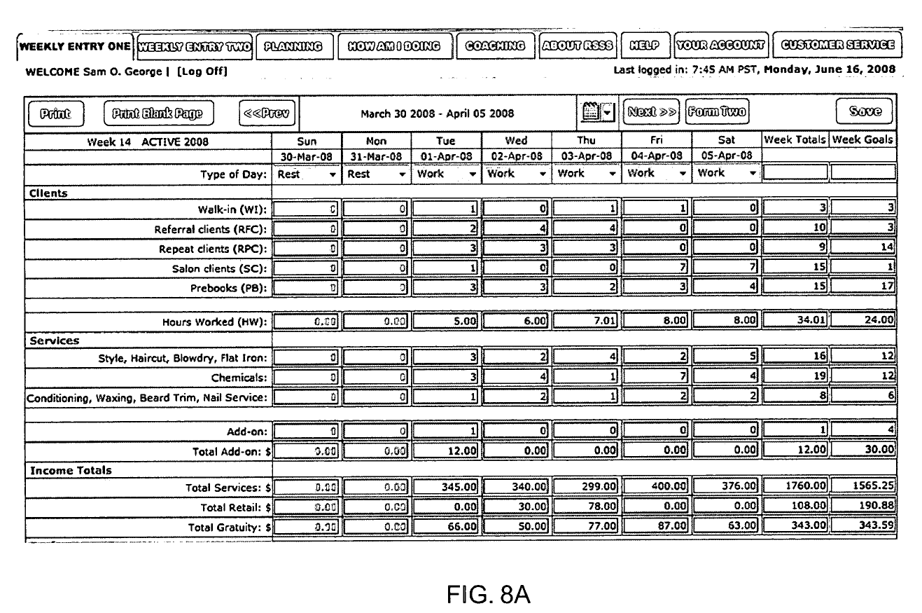

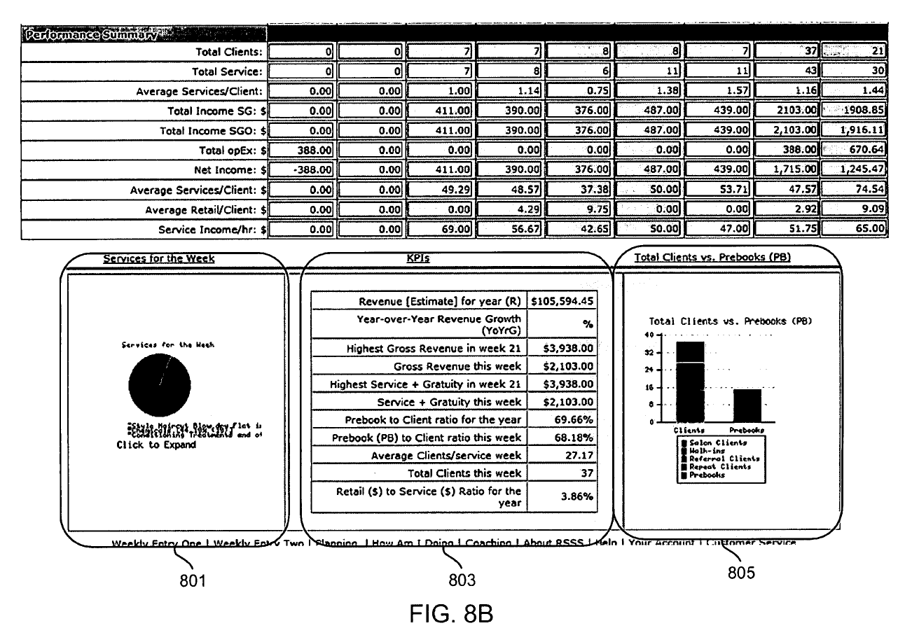

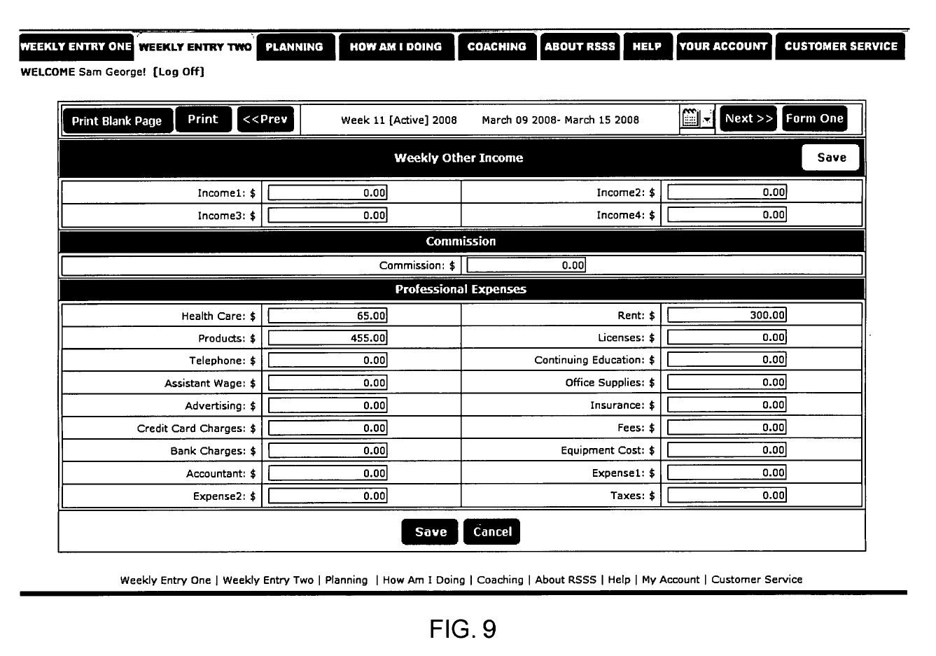

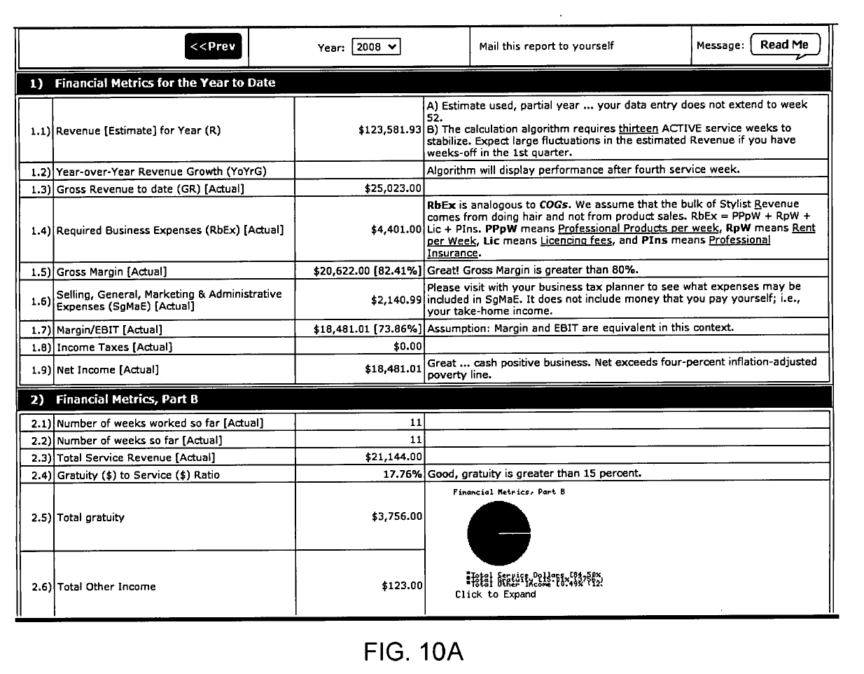

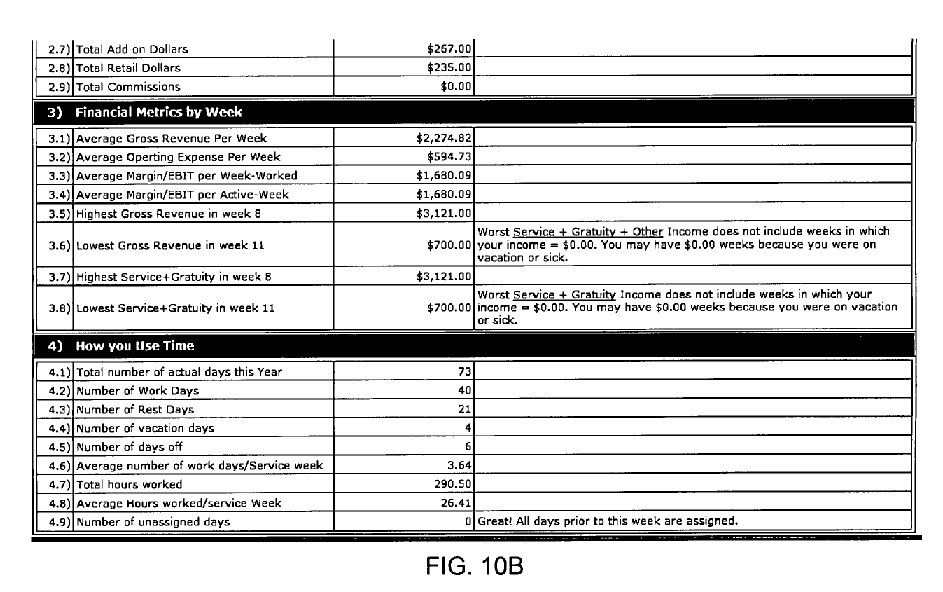

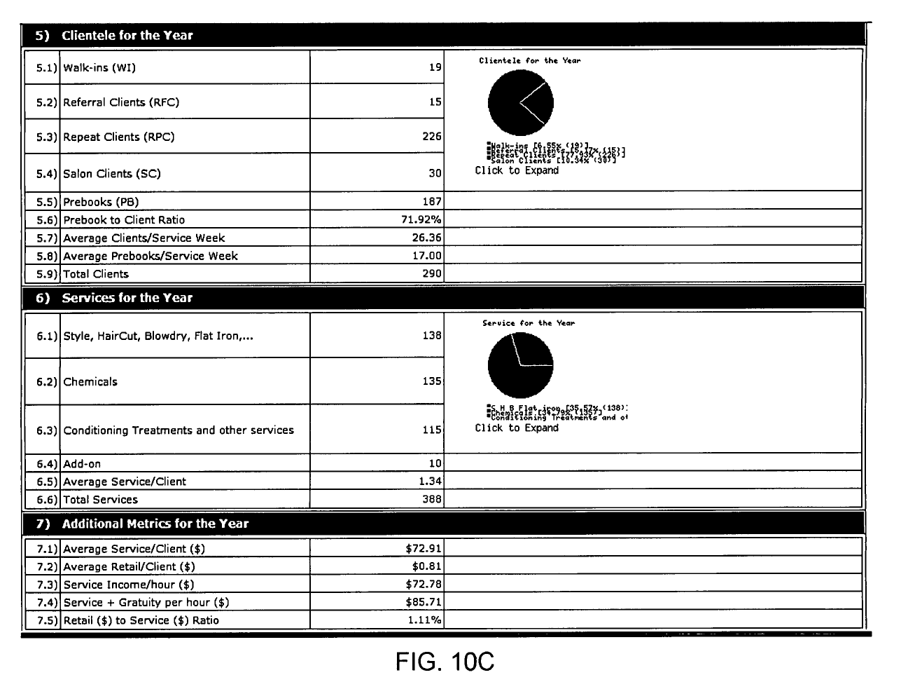

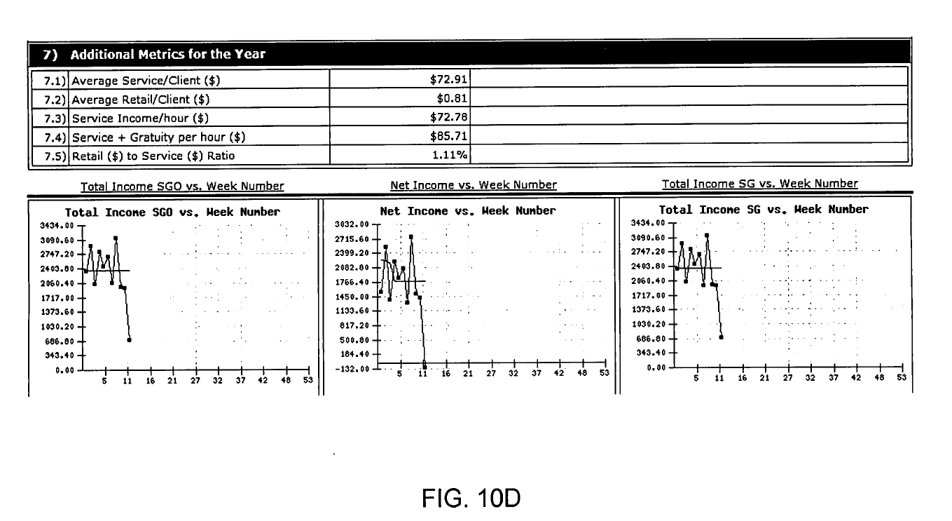

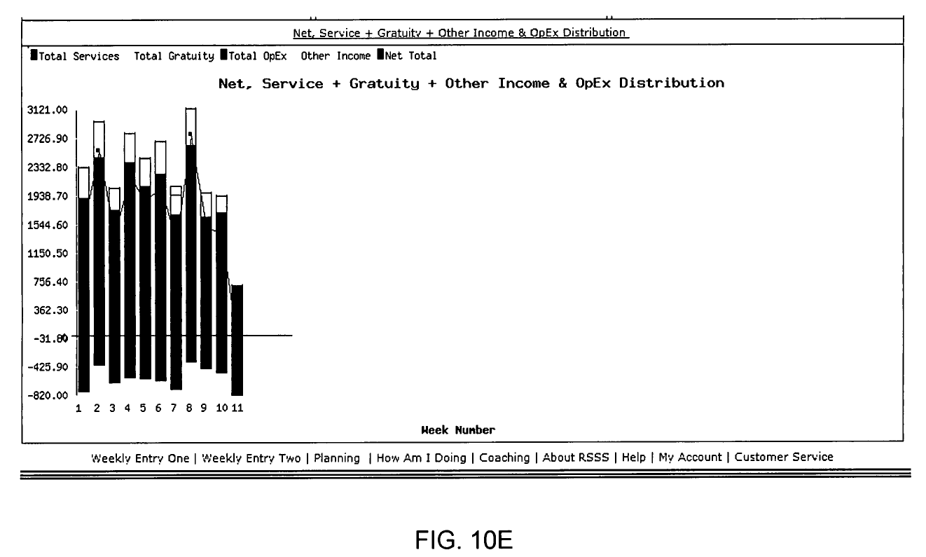

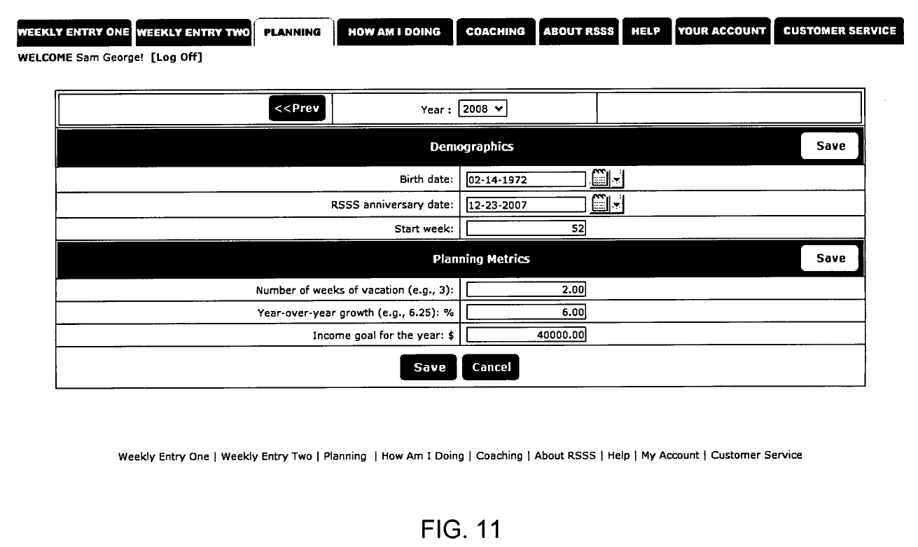

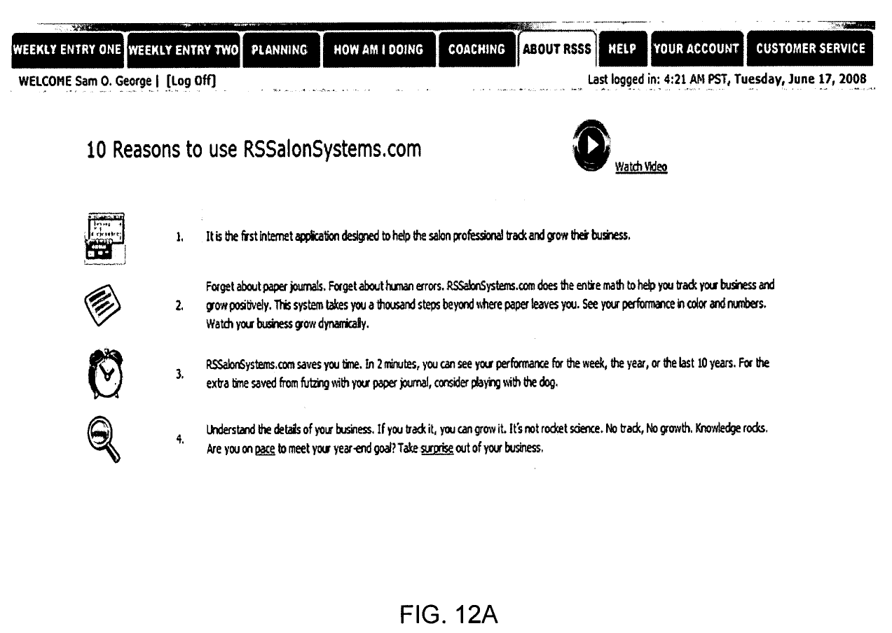

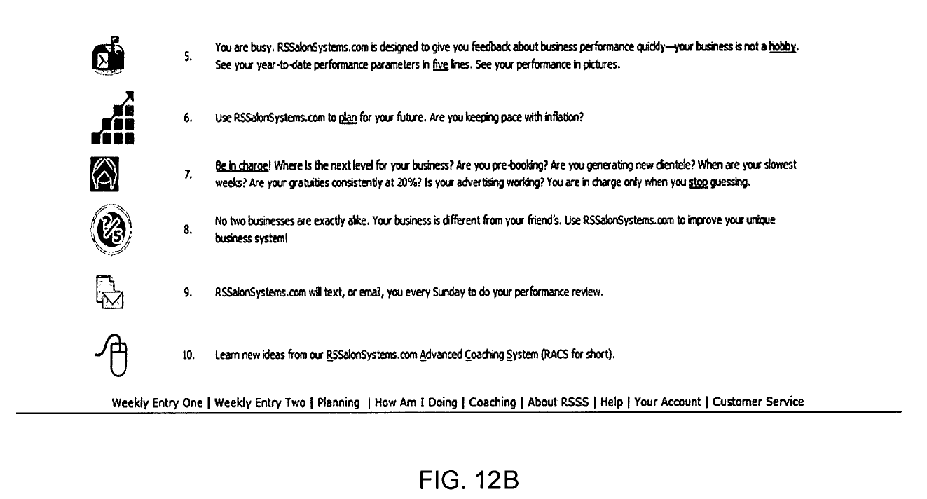

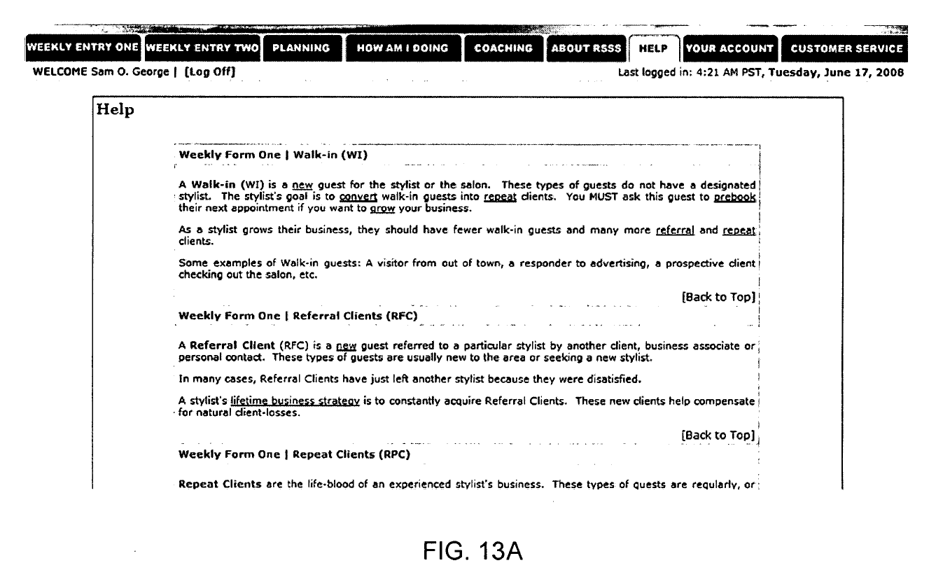

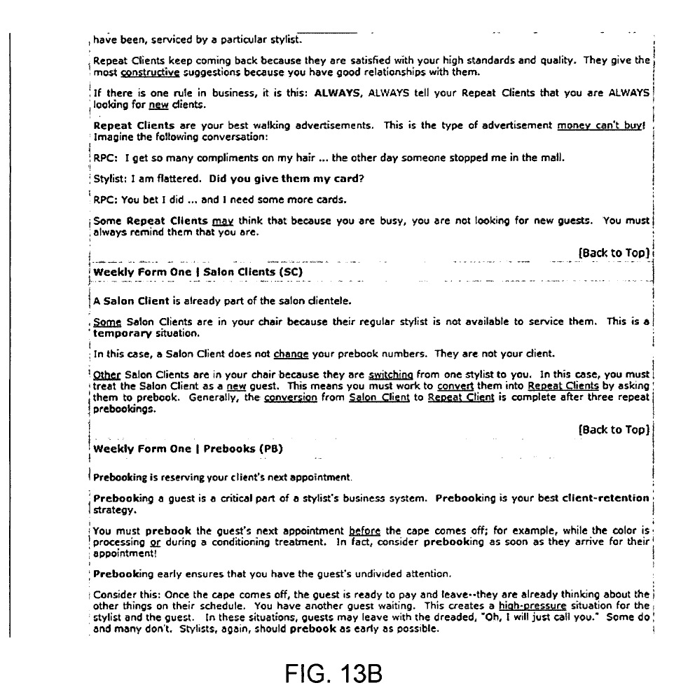

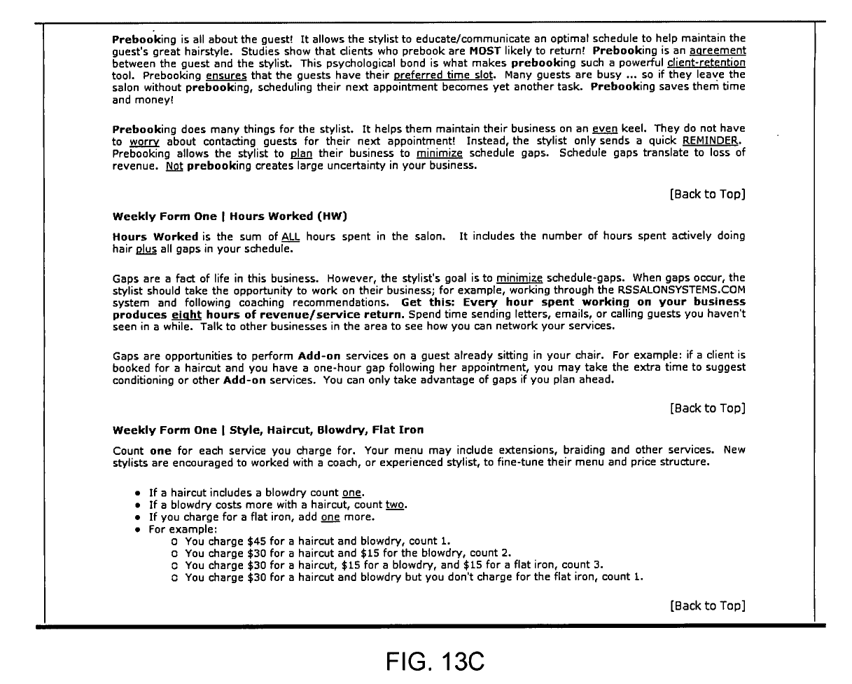

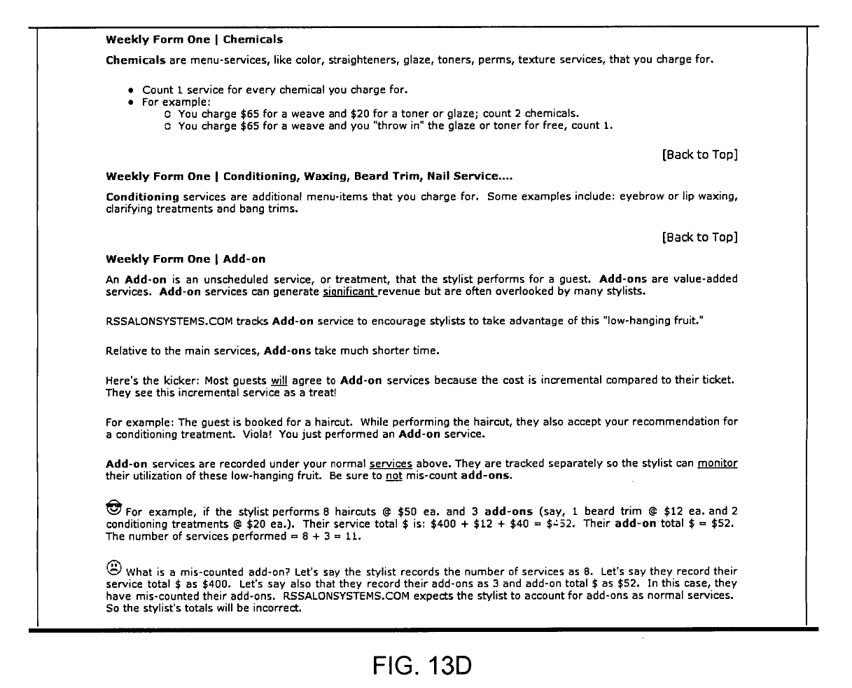

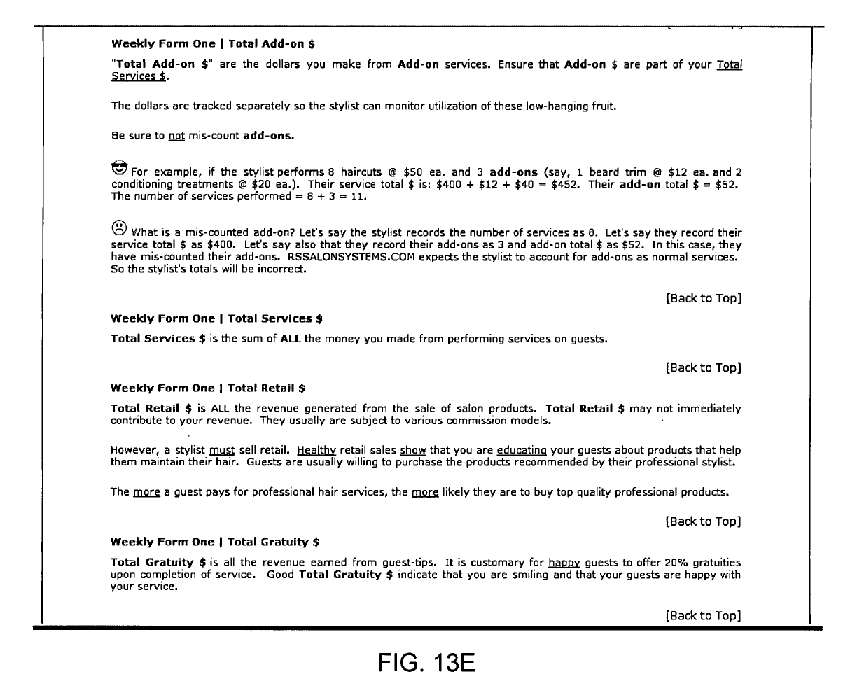

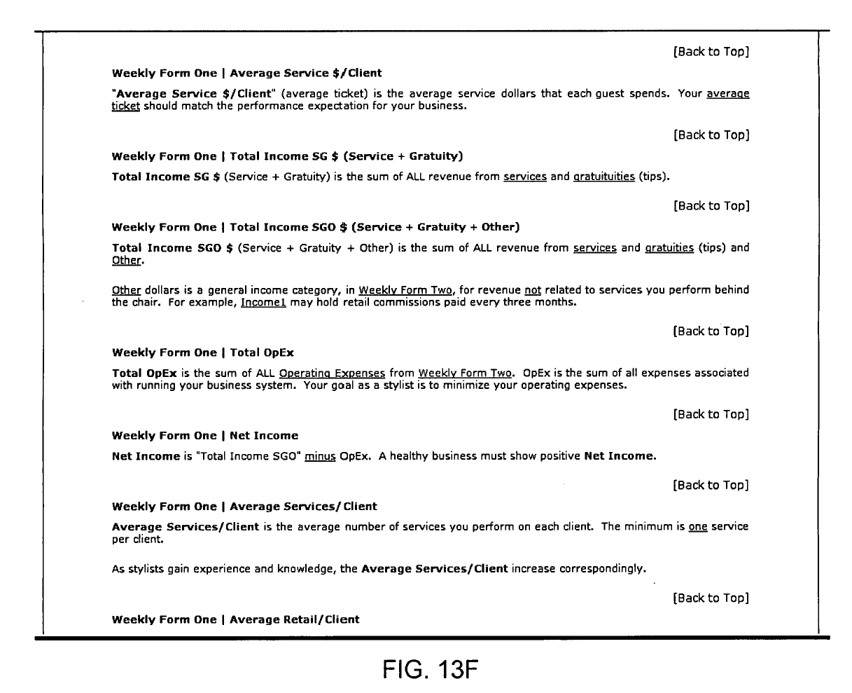

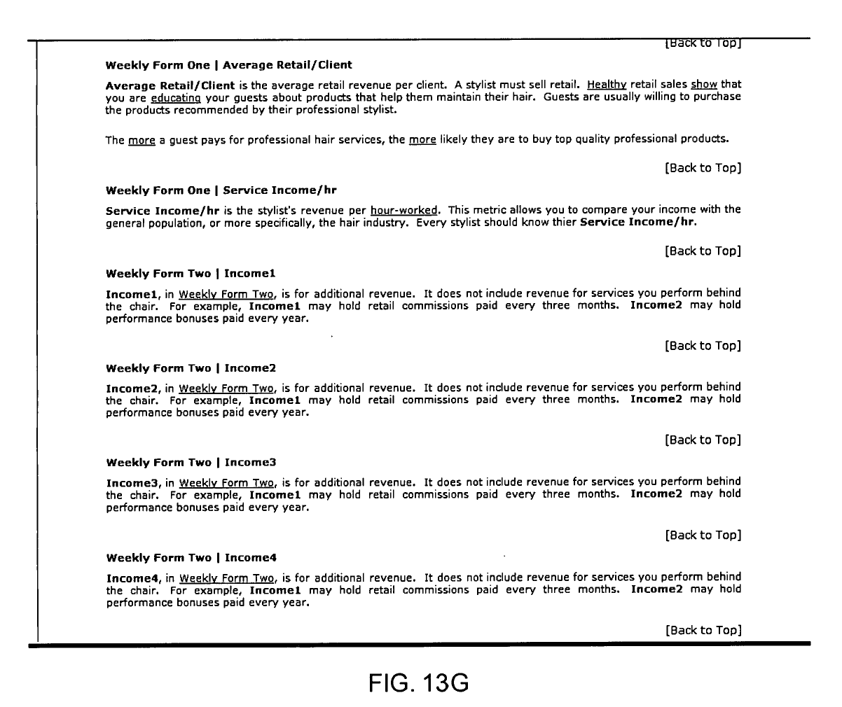

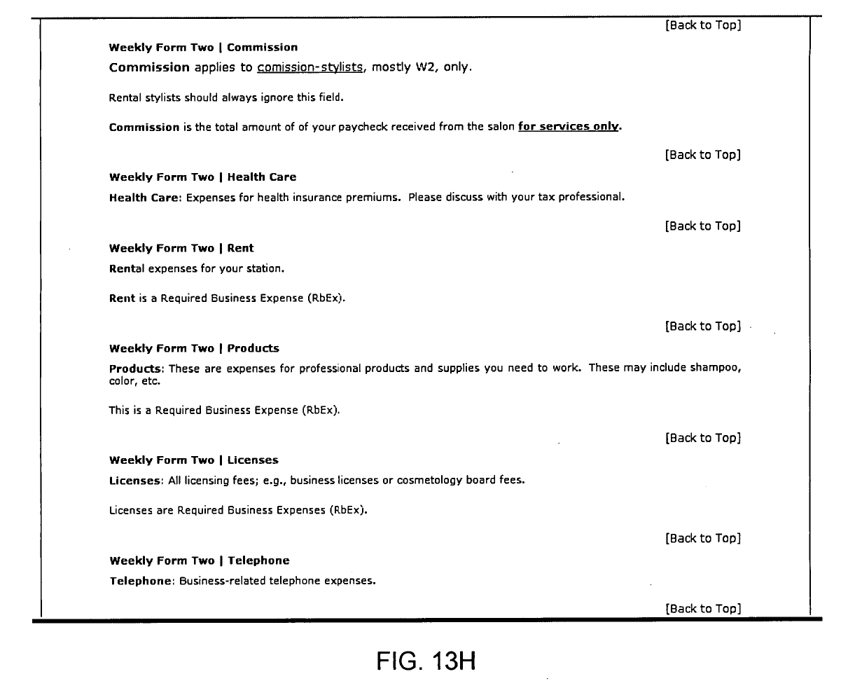

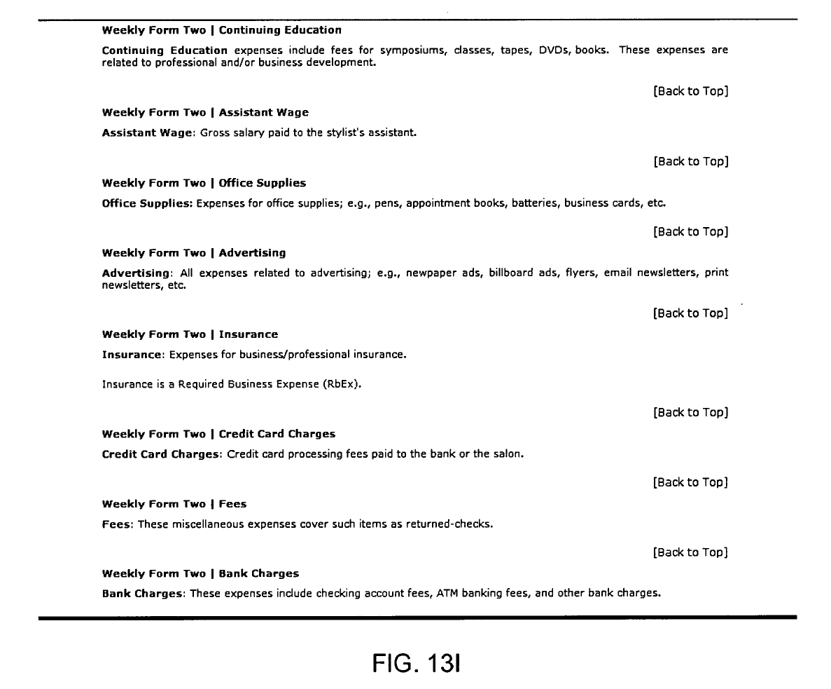

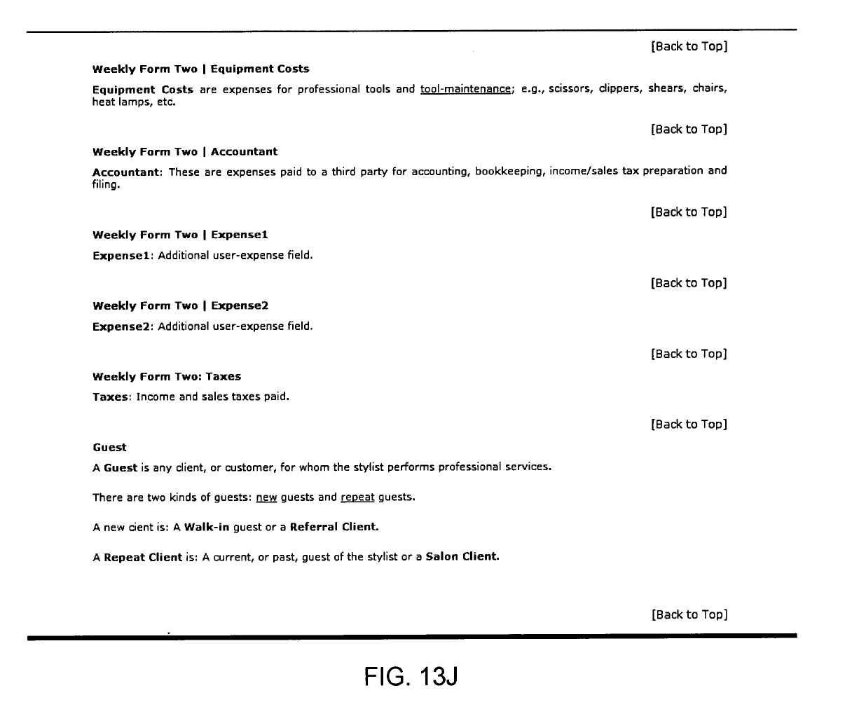

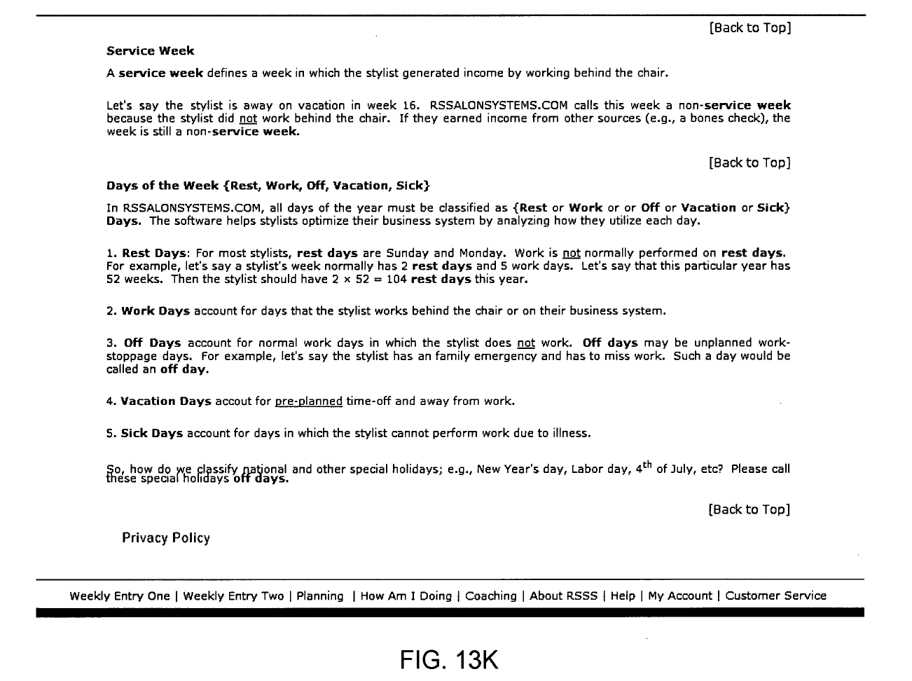

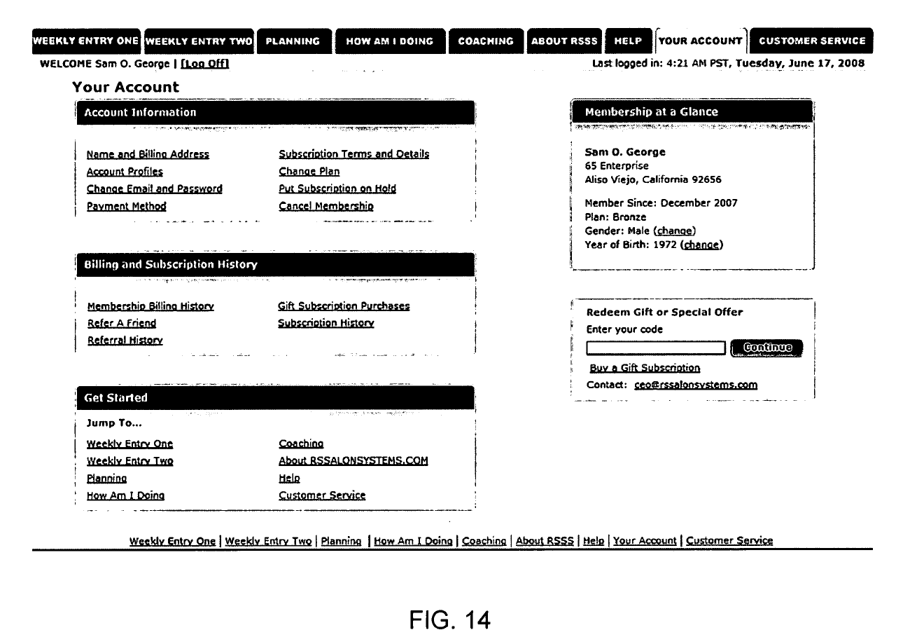

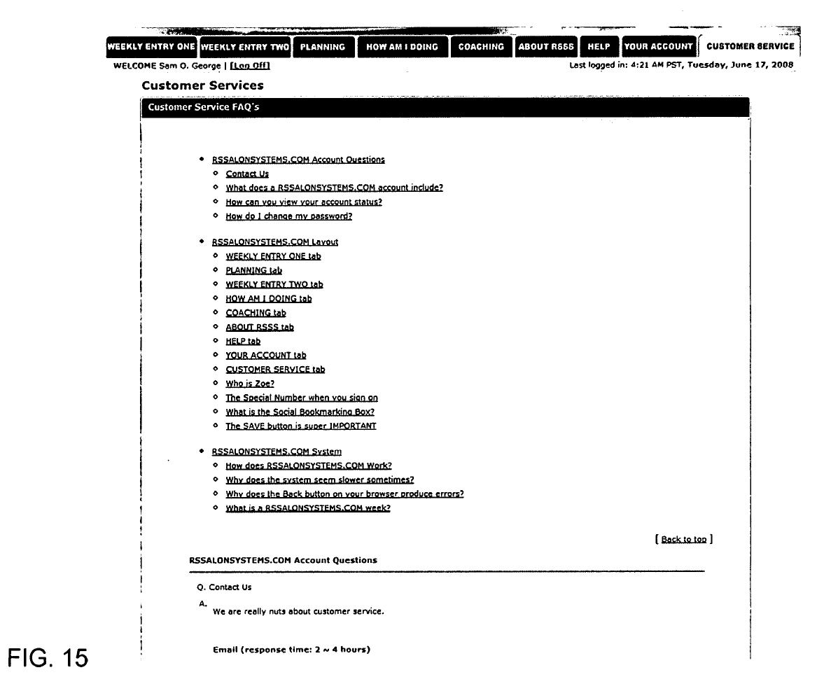

In the various embodiments, service professionals may access the server 10 via a user interface (UI) webpage provided by the server 10. Such UI webpages may be designed to include a public facing portal for accepting a user name and password (as well as other security authentication information) to securely log users into their respective personal accounts. Users may then access an easy-to-use personal webpage for extracting and communicating users' business performance data with the server 10. The UI personal webpage may be segmented into several web pages, including primary web pages in which business data, as well as secondary web pages are used for educating and guiding the users in the process of utilizing the embodiment systems. Examples of primary web pages are illustrated in FIGS. 8A-C “Weekly Entry One,” FIG. 9 “Weekly Entry Two,” FIGS. 10A-10D “How Am I Doing,” FIG. 11 “Planning,” and “Coaching” (not shown). Examples of secondary pages used for educating and guiding the users in the process of utilizing the embodiment systems are illustrated in FIG. 12 “About RSSS,” FIGS. 13A-13K “Help,” FIG. 14 “Your Account,” and FIGS. 15A-F “Customer Service”

For example, service professional users can enter business parameter data into the UI forms presented by the server 10 illustrated in FIGS. 8A, 8B “Weekly Entry One,” or FIG. 9 “Weekly Entry Two”. These web forms may be provided in a closed-loop. The initial entries may be survey forms for receiving user preferences.

The server 10 may be configured to use the concept of an “RSSS-week” to ensure that all weeks are identical. This requirement ensures that the functions performed by the server 10 remain accurate under all date-conditions. RSSS means RSSalonSystems.com, and an RSSS-week starts on Sunday and ends on Saturday. Week 1 of one year may start as early as December 26 of the previous year and will include January 1. The year is always rounded to include 52 or 53 whole weeks. For example, the RSSS week 1 of 2008 begins on Dec. 30, 2007. Calendar 2008 will have 52 whole RSSS weeks, while the year 2011 will have 53 RSSS weeks. Using an RSSS-week enables the system software implemented on the server 10 to avoid the constraints of date calculations found in other software systems. For example, in Linux®, week 1 always starts on January 1. This creates unique problems in date calculation because there are weeks that have less than 7 days. In Microsoft Excel®, the frame of reference is similar, but the results are different from Linux. The RSSS-week concept loosely resembles ISO8601 week number calculation standards in which the critical timing measures are days, weeks or years. Accordingly, the concept of a month is not germane to the core of embodiment systems implemented on the server 10 except for e-commerce billing purposes.

In the various embodiments, the server 10 may be configured to perform all the mathematical calculations associated with generating performance reports such as business operations, revenue-forecasting and goal-setting reports. For example, various self learning algorithms (including neural networks) and advanced pattern recognition features may be implemented in the server 10 to estimate trends and uncover business intelligence. The webpage forms capture daily performance data. Each page displays performance metrics real time. The server 10 may be configured to include a calculation engine that calculates all performance and tracking data. The data can be sent to custom C/C++ binary executables that perform the core mathematical manipulations. The calculation engine calculates totals, averages, parametric forecasting and other performance parameters and back-annotates to the webpage forms. The server 10 may also be configured to calculate weekly and yearly performance and back annotates to the webpage forms. Data and meta-data to generate Key Performance Indicator (KPI) tables and graphic objects (e.g. bar charts, pie charts, stacked charts) to show performance for 1 week or 1 year can also be calculated. The server 10 may be further configured to implement a database structure that allows it to store business performance data for the lifetime of each user.

In generating the performance report and the coaching priorities, the embodiment systems and methods utilize several types of algorithms to help service professionals track and grow their business on a weekly and yearly basis. Some algorithms employ multivariate analysis to develop a characteristic equation for the business and may employ more than 170 parameters to predict and calculate individual business performance. Some algorithms use mathematical, statistical and heuristic methods to refine the business model that is then used in a shooting algorithm to measure and predict individual performance as well as setting weekly goals for achieving desired year-end results. Such analysis allows the embodiment systems to generate real-time business performance reports. This also allows for parametric performance computations which can be used to coach service professionals. The embodiment systems are configured to calculate parameters based on learning the performance data of the individual service professionals. By calibrating learned business models against mined parameters from classes, the system is able to learn from the dynamics of groups and then re-reduce the parameters for each user's performance. The software can also re-calculate parameters from any previous date and re-optimize parameters in case a service professional has made errors in previous weeks. This algorithm allows the embodiment software to act as a learning agent, hence, providing users more accurate reports and projections as they provide more data to the system.

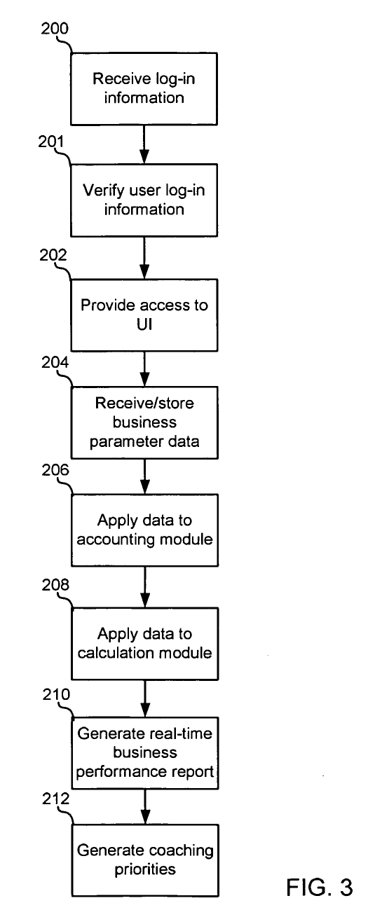

In an embodiment illustrated in FIG. 3 the server 10 may be configured to generate reports to assist hair salon professionals by tracking their business performance and providing coaching on ways they can improve their business. FIG. 3 is an overview process flow diagram of an embodiment illustrating the steps involved in tracking and coaching service business professionals based on business parameter data provided by the users. As described above, service professionals may access the server 10 via the Internet 60 and interact with websites generated by the server 10 to communicate their business parameters to the server 10. Before providing users access to individual accounts where they can enter their business data, the server 10 requires that users provide certain verification information, such as user log-in and password. This verification information is used to verify the identity of each user, ensure data is applied correctly and otherwise provide security for each user's personal business information. After receiving and verifying the verification information, step 200, the server 10 authenticates the user based upon the entered information, step 201. If the user is verified in step 201, the server 10 provide the user access to a user interface (UI), step 202, through which the user can input business parameter data. The inputted data is received by the server 10 and stored in a database, steps 204. The server 10 receives entered business parameter data, step 204, and applies the business parameter data to an accounting module, step 206, which uses a set of accounting algorithms to calculate business metrics. The sever 10 also applies the received data to a calculation module to generate the business model for the user's business using the currently entered data in conjunction with all prior data (both current year and prior year), step 208. The business model is used to calculate KPIs and future performance goals, the results of which are assembled in one or more webpages transmitted to the user's browser to provide the user with real-time business performance reports, step 210. The calculated results may also be combined with data regarding others in the same service industry (e.g., independent salon professionals) in order to provide peer comparisons and provide coaching to the user, step 212. These reports can be delivered as webpages or as other electronic documents for use by business professionals in optimizing their business.

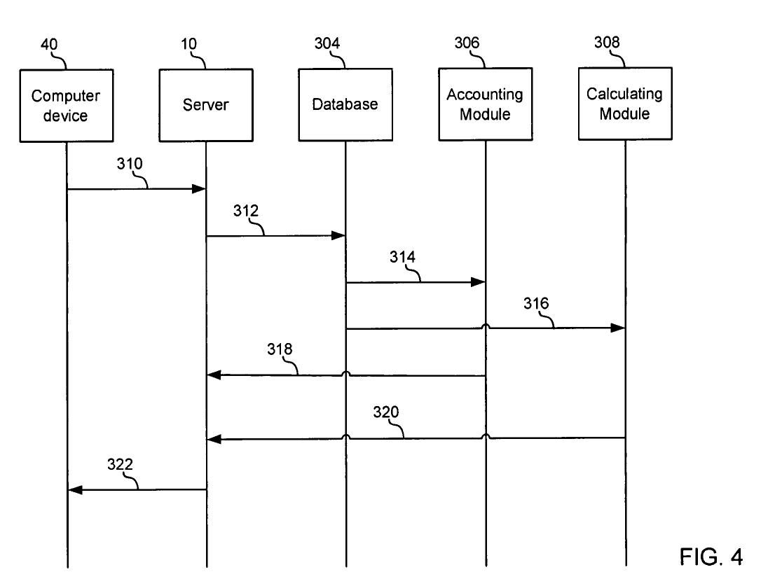

The process steps illustrated in FIG. 3 may be implemented in a number of electronic messages passed among different hardware and software layers in the embodiment system, such as illustrated in FIG. 4. Once users enter their information into a computer device 40, such as a desk top personal computer 40, the data is transmitted to the server 10, message 310. Before any calculations are done by the accounting module, users must first enter and save their weekly parameters into the system. This may be achieved by populating fields in webpages as shown in FIGS. 8A-B, 9 and 11. The server 10 then saves the information in a database 304, messages 312. To protect personal and proprietary business information received data may be encrypted before transmission and prior to storage in the database using any well known data encryption method. The data is submitted to the accounting module, message 306, which uses the data to calculate business metrics. The business data is also submitted to a calculating module 308, message 316, which uses the data, in conjunction with previous business data, to generate the business model which is used to calculate future performance goals. The calculation results from the accounting module 306 and the calculating module 308 are provided to the server 10, messages 318, 320, for processing into webpage reports. If data is maintained in an encrypted format, it may need to be decrypted before the webpage reports are assembled. The server 10 assembles the information into real-time business metrics reports and coaching tools which are transmitted to the user's computer device 302 for display, messages 322. Again, to protect personal and proprietary business information received data may be encrypted before transmission using any well known data encryption method such as SSL.

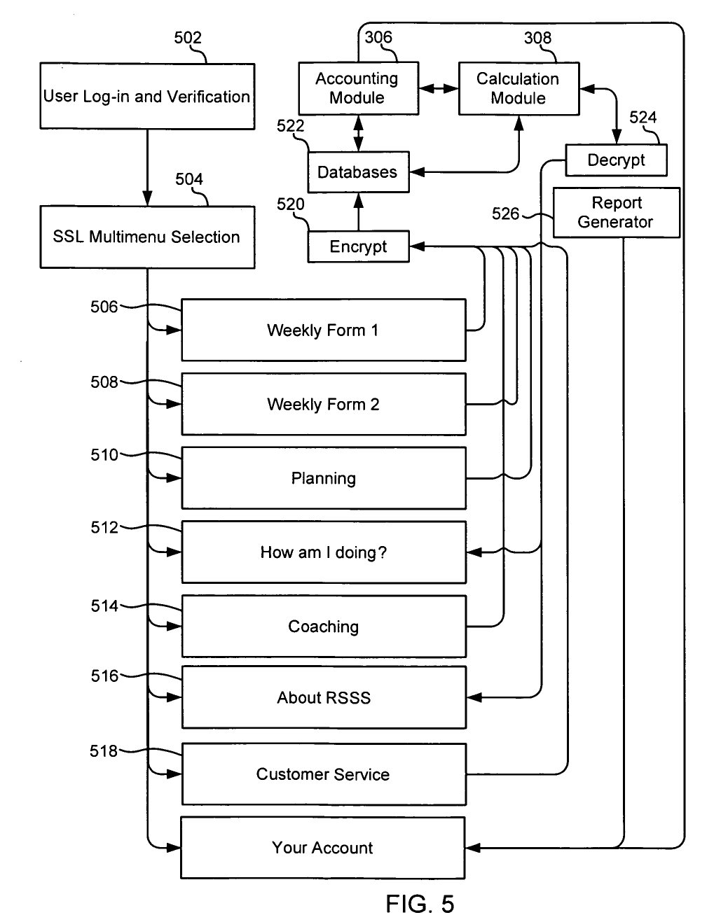

Dataflow among data entry webpages, a database, and the accounting and calculating modules is illustrated in FIG. 5. After a user has responded to a log-in page 502 and been verified, a multimenu selection page 504 may be provided to enable the user to select a task or report. Examples of a multimenu selection interface are included as part of the top menu bar illustrated in the webpages illustrated in FIGS. 8A and 9. In response to a user menu selection, a selected one of the available interface or report screens 506-518 will be generated by the server 10 and transmitted to the user's computer 40 for display. Data entered by the user in response to the webpage (e.g., entered into a data entry window positioned within the Weekly Form 1 webpage 506) can be transmitted to the server 10 where it may be encrypted 520 prior to being stored in a user account within one or more databases 522. As mentioned above, user data may be encrypted by the user's computer 40 prior to transmission and decrypted upon reception by the server 10 to protect against disclosing personal and/or proprietary information. User data stored within the databases 522 may then be provided to the accounting module 306 and/or the calculation module 308 for performing the analyses described herein. Results of calculations may be stored in the databases 522, and may be used by a report generator 526 to generate one or more reports to be transmitted to the user, such as the “How am I doing” webpage 512. If data is maintained in an encrypted format within the server 10, it may be decrypted 524 prior to generating webpage reports. As mentioned above, the report webpages may be encrypted by the server 10 prior to transmission and decrypted upon reception by the user's computer 40 to protect against disclosing personal and/or proprietary information.

While the foregoing description refers to the server 10, database, and the accounting and calculating modules as if they are separate units, these functions may alternatively be accomplished by a single server 10 configured with software instructions to perform the separate functions, by a server 10 coupled to a database server 304 and to computational processor configured with software to perform the functions of the accounting module and the calculating module, as well as by other combinations of processor units and software modules.

In the accounting module, be it a separate processing unit or a software module implemented within the server 10 itself, accounting parameters and business metrics may be computed for the current RSSS-week and for all weeks for which data is present up to the present date. The server 10 may be configured with software to help service professionals manage their business to sustain year-over-year positive growth in revenue Income (Gross and Net). The accounting module software may be configured to maximize or minimize a plurality of core-business parameters, such as estimated revenue, actual revenue, year-over-year revenue growth (YoYrG), required business expenses (RbEx), gross margin, selling & administration expenses, margin or earnings before income tax (EBIT), income taxes and net income. The server 10 may be configured to display business performance using a modified definition of velocity to express the internal rate of change (i.e., growth or decline) over time of any of a plurality (e.g., about 15-25) of business parameters. However, each core-business parameter depends (strongly or weakly) on many more parameters. The complex space expands because sub-variables in turn show implicit dependencies on other sub-variables. For example, the system analysis for each user can operate on the 47 intermediate parameters listed in FIGS. 10A-10D Sections 2 thru 7.

Because the system software is preferably designed to minimize data entry for users, it may not be obvious how dollars are distributed between services, or how services are distributed among clients. However, more data is not required when correct formulation of equations and algorithms in this embodiment are used. For example, a user may know a-priori the current week revenue, R_{CW}. This information may be entered by a user in response to the Weekly Form webpage FIG. 8A. The system software formulates dynamic business models by operating on the four performance classes, i.e., clients (C_{CW}), services (S_{CW}), time (T_{CW}) and revenue per client (R_{Ticket}), and their interrelationships. The system further uses longitudinal data to estimate current year earnings (E_{CY}). The algorithms may calculate and calibrate goals for the future weeks, but the system software may only generate webpage reports displaying goals for the next week.

The algorithms can apply smoothing functions (e.g., spline fitting) to smooth out some discontinuities in data reporting. For example, many service professionals pay estimated taxes on a quarterly basis, and some service professionals receive merchandising checks every six months. In these cases, anomalies in data entry do not affect the accuracy. Such smoothing (or filtering) functions are discussed below.

An objective of the various embodiments is to assist service professionals in sustaining Year-Over-Year-Growth (YoYg) in revenue (gross and net) while minimizing work-time (HW) and expenses. Both terms are dependent on various interrelationships of the constituents of the service professionals' business dynamic model (BizMod).

Current year Year-Over-Year-Growth (YoYg_{CY}) explicitly relates revenue for the current year, R_{CY}, with revenue for the previous year, R_{PY} via equation [1].

$$Y o Y {g}_{C Y} = ( \frac{{R}_{C Y}}{{R}_{P Y}} ) \% \qquad [ 1 ]$$

Current year revenue (R_{CY}) can be a generalized function of the business model (BizMod) as embodied in equation [2].

$${R}_{C Y} ≡ \underbrace{{λ}_{C} \cdot C ( {λ}_{S} \cdot S ( {λ}_{T} \cdot T ) )}_{Biz Mod} \qquad [ 2 ]$$

where:
R_{CY} is the estimation of revenue for the current year;
C≡number of clients per week;
λ_{C}≡a revenue-per-client function that embodies the constituents of the client-class: walk-in (WI), referral clients (RFC), repeat clients (RPC), salon clients (SC);
S≡number of services performed on clients;
λ_{S}≡a revenue-per-service function that embodies the constituents of the services-class: “Style, Haircut, Blowdry, Flat-iron” (SHBF), Chemicals and “Conditioning, Waxing, Beard Trims, Nail Service” (CWBN);
T≡time-worked per week—includes time spent per client; and
λ_{T}≡a revenue-per-hour function that embodies the constituents of the time-class: hours-worked, time spent per client-service.

Equation [2] is a simplified embodiment of the business model. It basically provides that services are a function of the number of clients and time-worked is a function of services performed. This equation can be rewritten from a services perspective without loss of generality.

Equation [2] represents time-series data that are collected daily, weekly and yearly. So a more complete formulation of equation [2] is in the form presented as equation [3].

$${E}_{{R}_{C Y}} ≡ {\sum }_{n = 1}^{w max} \underbrace{{λ}_{C} \cdot C ( {λ}_{S} \cdot S ( {λ}_{T} \cdot T ) )}_{Biz Mod} \times {W}_{n} \qquad [ 3 ]$$

where:
wmax≡max number of weeks in year (52 or 53);
E_{R}_{_{CY}}≡the expected revenue for the current year.

The various embodiments implement the embodiment of equation [3] in a “shooting algorithm” which is used to forecast total revenue performance for the current year based on weekly data entered by the service professional. In other words, the shooting algorithm estimates where the services professional will end up at year-end in terms of total revenue based upon data entered up to the present week. The term “shooting algorithm” is used because, like ballistic projections, the algorithm predicts a future outcome based upon present trajectory information (i.e., previous and current week business data).

The shooting algorithm relies upon a business model for the service professional's business which is generated each week based upon the latest (as well as all previous) business data. The generation of the business model is conducted in two parts or algorithms, with the first part applied to preexisting prior-year business data and the second part applied to current present year business data (i.e., present year business data and present year projections). In both parts the same basic regression analysis equations are used but in a slightly different manner. If there are gaps in business data, such as missing days or weeks of business results, smoothing functions are applied to the data before the analysis is begun; no smoothing of data may be required if the data is contiguous—i.e., without gaps.

As explained in more detail below, a family of four mathematical analyses is performed in each of the two parts or algorithms, namely: multi-dimensional multi-variant regression analysis; aspects of neural network analysis; time varying statistical analysis; and a heuristic analysis.

Multi-dimensional multi-variant regression analysis is the workhorse analysis tool for all algorithms used for defining a mathematical model of the business. As is well known in mathematics, a regression analysis determines an equation, referred to as a characteristic equation, which most closely matches a set of data comprising known inputs or variables and known results. In a multi-dimensional multi-variant regression analysis, data for multiple inputs or variables are analyzed to determine a multi-variable characteristic equation that best matches the data set. In the present invention, the multi-dimensional multi-variant regression analysis analyzes the business data set which includes information regarding the users' clientele, work practices, expenses, and revenues, tracking these inputs in multiple categories. The multi-dimensional multi-variant regression analysis is actually done twice. The first regression analysis sets a baseline of business model coefficients and is used to generate a first estimate of year-end results. In the second analysis, some of the data and projections generated in the first regression analysis are assumed to be at least partially correct, and used to recalculate the end point (i.e., year-end results projection) in a second multi-dimensional multi-variant regression. With two different end point estimations generated, further analyses can be used to estimate the most likely result. Since multi-dimensional multi-variant regression analysis is performed multiple times in generating the final business model, the calculations may be performed in a module or regression engine within the server or calculation module.

Neural network analysis is used to perform some classifications of the business and to initiate the re-regression of the data. Regression analysis is built into the neural network analysis, so the same regression module may be used a number of times in the neural network analysis, although the regression analysis is used differently in the neural network analysis.

Time-varying statistical analysis is then applied to the results of the regression analyses to obtain a different year-end estimation. Statistical analyses can identify and accommodate random fluctuations in business data, such as one-time expenses and unusually busy weeks, and thereby avoid extrapolating random events into year-end projections or periodic business events.

Finally, all of the results of the regression analysis of both prior years business data (which provides a baseline model), regression analyses of present year data and projections, neural network analysis of present year data, and time-varying statistical analyses are combined in a heuristic analysis to generate a final model of the business. Heuristic analysis refers to a problem-solving technique in which the most appropriate solution out of several solutions found by alternative methods is selected at successive stages of a program for use in the next step of the program. The final business model or characteristic equation is then used in the shooter algorithm to arrive at year-end projections, re-optimize the business projections, calculate business growth, and set next week's (or other interval) goals. The output of this analysis is then presented to the user in webpage displays such as illustrated in FIGS. 8A-8C, and 10A-10E. Thus, the extensive analysis conducted on the prior and present year business data boils down to the summary projections and goals displayed in a format that the user can easily understand, such as in the form of numerical goals in FIB. 8A, pie charts 801, analysis tables 803 and bar graphs 805 shown in FIG. 8B.

Year end projections are used as the end point for projection calculations so service professional users can manage their business to achieve year-to-year growth goals. Daily and weekly business volume and profitability is typically quite volatile, with customer volume and periodic business expenses varying significantly day-to-day and week-to-week. By modeling the business over a longer period of time, such as a year, such variability can be modeled correctly. Additionally, many service professional businesses experience holiday and seasonal variability, such as increased volume during some seasons and decreased or more variable volume during other seasons. By modeling the business on a yearly basis, such seasonal variability is easily recognized by the analysis and incorporated within the business model. Also, many individuals prefer to assess their own progress and business performance using year-over-year measures, such as year-over-year growth (e.g., percentage or total dollars) in revenues or profitability. Additionally, many service professionals plan their lives in units of years, such as selecting a year in which they want to retire or setting five-year goals, so performing the analysis based on year-end projections enables the results to fit user expectations and paradigms.

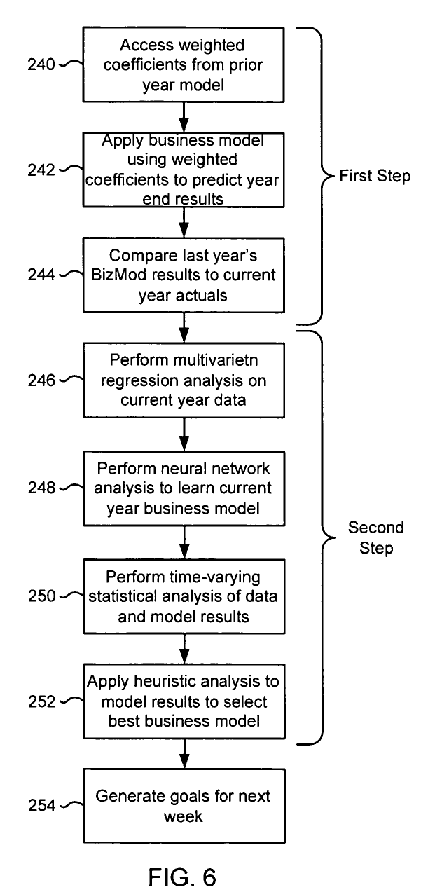

The overall analysis to generate the business model is iterative, but the analysis proceeds in two basic steps as illustrated in FIG. 6. In a first step, the analysis generates or obtains a model of the business (or uses a previously generated model) using business data from prior years including desired growth targets (e.g., the year-over-year growth the user would like to achieve), step 240. This model is used to project a current year performance based upon the seasonal variability of the business reflected in the model, step 242. These projections/assumptions are then tested against previous year results, step 244. Then in a second step the business model is refined using current year results, steps 246-252, and new projections/assumptions generated which can also be tested against current year results. Finally, the new/refined business model is used to generate goals for next week, step 254.

Last year's business model characteristic equation coefficients are set based upon the known year-end results. To set a goal for current year performance, a simple linear growth calculation is used. For example, if the user has set a goal of 6% growth for the coming year, a simple projection can be calculated by increasing last year's year-end result by 6%. This sets the current year's end goal. However, the week-to-week, month-to-month and season-to-season variability typically experienced in service professional businesses means that weekly and monthly goals cannot be so simply calculated. Instead, the business variability can be expressed in terms of a time-based characteristic equation which reflects both the user's work pattern and seasonal variability in revenue and costs.

Last year's characteristic equation of the business is known because it is based upon the weekly and year-end performance of the previous year is known. The “characteristic” equation(s) of the previous year is also known—i.e., all weighting coefficient-sets, λ, are known through multi-dimensional correlations. These are the baseline-sets that conform to the formulation of Equation [3]. This characteristic equation of the business, interchangeably referred to herein as the business model, can be used to calculate a baseline of weekly business goals which would be consistent with meeting the current year-end goal (which in the case of the example would be 6% more than last year's results). The week-to-week and season-to-season fluctuations in business performance reflected in the business model can be used to allocate year-end goals in a realistic manner. Thus, to meet a year-end goal of increased revenues, the desired increase would not be evenly allocated to all weeks, and instead is allocated more heavily (e.g. by use of a weighting function) to weeks in which an increase in revenue would be easier to achieve, such as to those weeks that the business model shows are likely to be slow. For example, if the year-end goal is a 6% increase in revenues over last year, that total increase may be allocated disproportionally in weekly revenue goals to weeks that the business model anticipates will be less busy, while weeks that are anticipated to be fully booked may be allocated weekly goals consistent with prior years. At the start of a new year, the previous year's business model is the best predictor of the current year results.

While the baseline business model based on previous year data provides a beginning basis for allocating weekly goals to achieve year-end objectives, the business may (or may not) have a different characteristic equation in the current year. For this reason the business model needs to be adjusted or relearned as the year progresses using current year data. Then using the adjusted or relearned current year business model, a year-end projection can be made using the shooter algorithm. This year-end projection can then be compared to the linear or goal projection (e.g., 6% growth) to see whether current year performance is likely to result in achieving the year-end goals, and to set weekly goals to assure the year-end objectives are met.

The current year's business model is developed using the multi-dimensional multi-variant regression analysis, neural network analysis, statistical analysis and heuristic analysis described above because the current year may likely to be quite different from the prior year. For example, the user may be working in a different pattern (e.g., changing the particular or number of days worked each week or month), or the user's client base may have shifted, such as transitioning from primarily walk-in clients to predominantly appointment clients as typically occurs as professionals build a loyal base of clients. Changes in the user's work pattern, client base, cost structure, and productivity (to name just a few) will result in a different characteristic equation of the business in the current year. Therefore, the prior year's business model (i.e., characteristic equation) cannot be blindly used to set goals for the next week simply by increasing last year's results by the user's year-over-year growth target. Such a simplistic approach could result in useless performance targets if the business has changed in some manner. Last year's business data and business model are nevertheless important for calibrating the analysis, particularly in terms of identifying seasonal variability. Seasonal variability can be easily obtained from prior year business data but may be difficult if not impossible to anticipate if future business projections are based solely upon current year business data. For example, a significant drop off in revenues during the week of Thanksgiving would not be anticipated by analyzing business data from the preceding ten months.

For the current year, the system software derives a new characteristic equation that is independent of the previous year but uses the previous year characteristic equation as an input. The formulation also follows equation [3] but the current year equation(s) depend on known and unknown data. The current-year λ coefficient sets are calibrated against the patterns learned from the prior years' data. Calibration refers to adjusting the coefficients in the business model, such as adjusting the coefficients determined from prior year data to take into account present year goals and results while maintaining the patterns within the prior year business model. This check ensures that the current-year modeling incorporates the learned dynamic business model (BizMod) of the service professional. The second sub-algorithm then does a number of difference-analyses between current and prior-year λ coefficients. If the difference between current and prior-year λ coefficients are within error margins, the system will model the expectation of current year revenue based on learned behavior—this means that the current year is a strong function of the learned business model.

If the coefficients are very different, the system then expands the application of shooting algorithms to learn the new model and to derive a year-over-year-growth estimate for the current year that is consistent with current year performance. In expanding the application of the shooting algorithm, more analyses are performed. First, if the prior year business model is very different from current year performance, then the current year business model will be a weak function of last year's business model, which requires the system to learn the current year's business model (i.e., discover the coefficients of the characteristic equation which describe the business in the current year). In this case, the prior year business model is used as a baseline but is a weak function in the overall multi-variant calculation for the current year's dynamic BizMod. Instead, the current year's business model will be discovered or learned based primarily on current year data. For example, if after three weeks of business data the analysis shows that the business is significantly underperforming the business model, and as a result is projected, based on the prior year business model, to result in a year-end total revenue that is $16,000 less than the goal, last year's business model is not matching this year's data. In this case, last year's business model is kept as a baseline and as one calculation end point projection (i.e., year-end result), but the regression analyses of current year data provides a second end point projection.

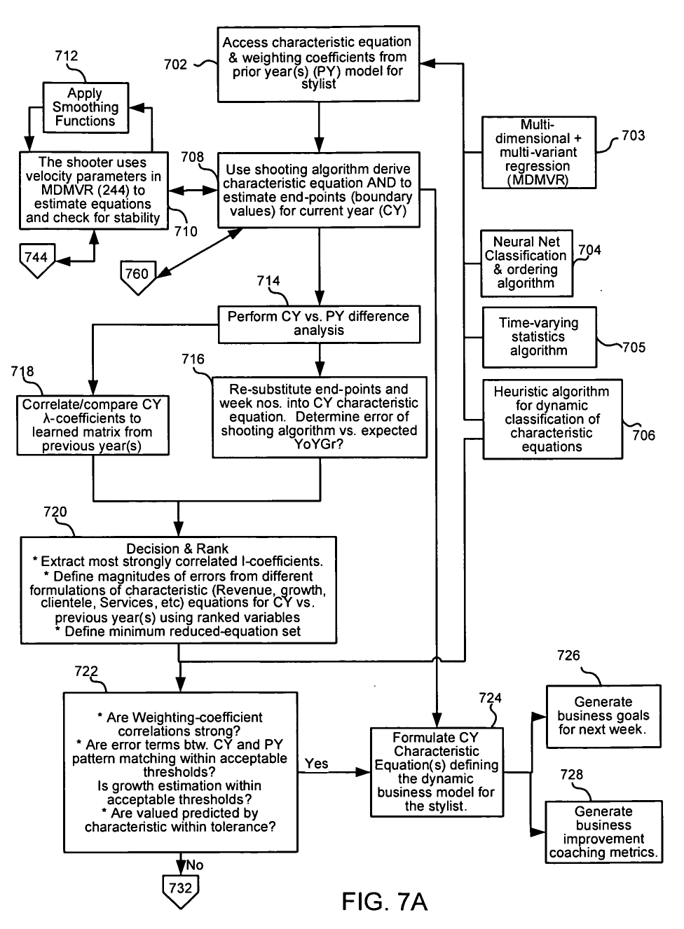

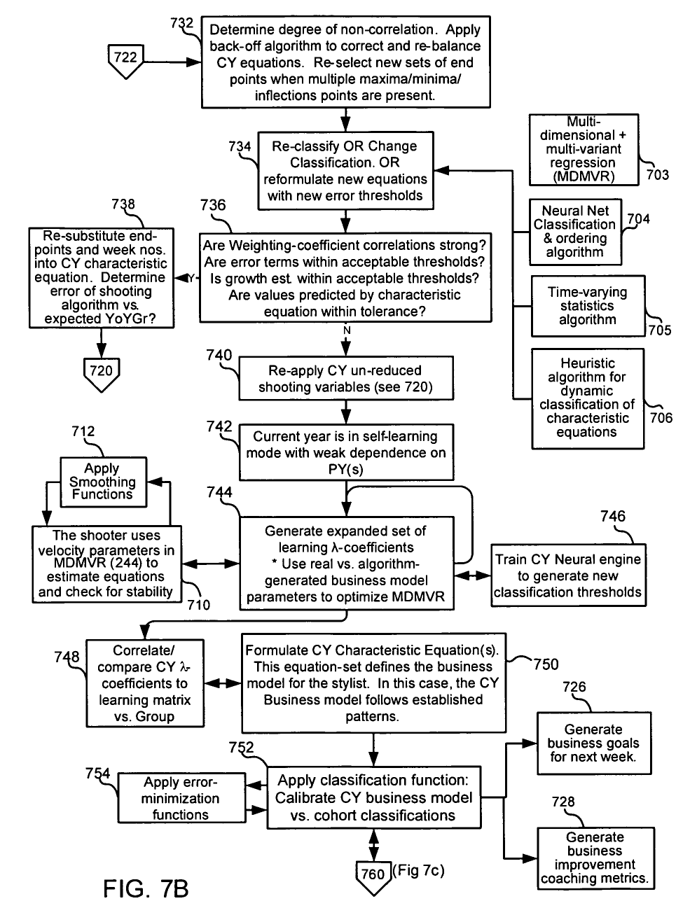

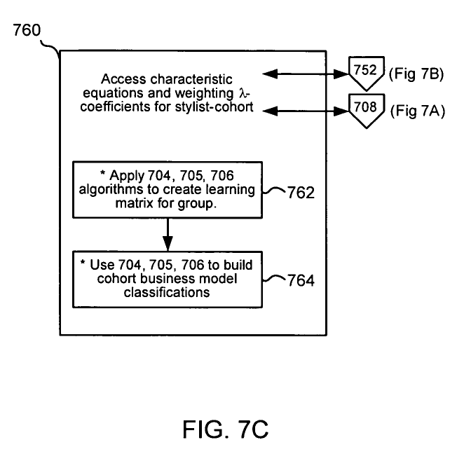

To develop a new business model (BizMod) for each service professional, multi-dimensional multi-variant regression analysis may be conducted on all data entered to date using a plurality of data input parameters and sub-parameters, step 246. An illustration of steps that may be implemented in generating the unique business model are illustrated in FIGS. 7A-7C described below. The resulting business model equation may be a multi-segment equation containing linear (i.e., no parameters or sub-parameters are raised to a power other than 1 in the equation), cyclical, sinusoidal, or polynomial (i.e., one or more parameters are raised to a power other than 1) segments. In this analysis, each parameter and sub-parameter are equivalent to dimensions in a multidimensional analysis. Further, the BizMod equation may only have closed-form mathematical solutions within certain epochs. The overall BizMod equation may not have a closed-form mathematical solution. If the characteristic equation is a composite equation that does not have a closed form solution, it may be solved algorithmically. In this case the heuristic algorithm relies on multi-dimensional multi-variant regression analyses, neural network analyses and statistical analyses to formulate the equation and determine how best to reduce the error terms within any subset of epochs.

Two more algorithms are then applied to the data which gives the shooter algorithm more data to work with. First, a neural network analysis can be performed, step 248. As part of this analysis, the service professional's business may be classified within an appropriate cohort group. Also, the neural network analysis can perform another iteration of multi-dimensional multi-variant regression analyses, this time beginning with no assumptions on the model coefficients to learn the business model. The results of the neural network will be a different set of year-end projection estimations. This algorithm produces a new BizMod equation candidate.

Second, a time-varying statistical analysis is conducted comparing each data element (i.e., subclassification of business data) in the current week relative to all of the data in previous weeks or of the current week to the same week in prior years. The results of these analyses are probability estimates of how close each one of the expectation variables is to the “best” business model.

It may turn out that the user is seriously underperforming in the current year. In that case all the multi-dimensional multi-variant regression, neural network and statistical analyses may indicate a most likely consistent business model for the current year. That business model is then given to the shooter algorithm to generate a final prediction for the current year. At this point, the system software has learned from the regression analysis of prior year's data what the pattern was from last year and the system knows that the current year business model is a weak function of the prior year business model, knows the new pattern for the current year based upon the multi-dimensional multi-variant regression analysis (step 246), neural network analysis (step 248) and statistical analyses (step 250). Using this information the system software uses heuristic analyses to select a best business model, step 252. Finally, using the selected best business model, the system software reoptimizes the business weekly goals to values which if met are likely to lead to achieving the year-end goal, step 254. In this case, the new business model will be a weak function of the prior year business model but with the new patterns included. Thus, in the situation where the current year data departs significantly from the predictions based on the prior year business model, the prior year business model may be used to set some of the underlying patterns.

Performing the regression analyses iteratively helps to correct for offsets. The terms “offsets” or residues refer to quantities that result from the application of regression equations to a data set The regression analysis is a function of the contiguity of the data being analyzed; the closer that the regression analysis is able to fit a characteristic equation to the data set, the smaller the residual. The various methods may calculate an expected revenue value and a large residue term, in which case the analysis methods must be applied iteratively to generate a better characteristic equation that reduces or eliminates the residue term using a number of components in the shooting algorithm.

The focus in these analyses is simultaneously on the whole year end goal and on next week's performance goals, with the whole year business model balanced each week for the entire year to assure that the year-end goal will be achieved if the next week's goals are met.

If the current year model projects a year-end result that is less than the goal, the week-to-week and season-to-season variability pattern reflected in the new current year business model (i.e., characteristic equation) can be used to set business goals for the next week and/or month that are consistent with the seasonal and weekly variability of the business. The goals for each week may change in sync with the business's variability pattern. If each weekly goals are met even though some weeks have higher or lower goals, this performance will set the user on a course to achieve the year-end goals. Thus, if current year data shows the business well below the performance needed to reach year-end goals but the next week falls in a period of low revenue based upon the seasonal pattern of the business and the user's work pattern reflected in the business model (e.g., the next week includes Thanksgiving), the goals for next week may be modest compared to weeks in which the business model suggests that greater volume can be expected (e.g., the next week falls in prom season). However, those modest goals may represent a disproportional increase over the results of the same week last year. In this manner, the analysis and projection methods can set realistic goals which are more likely to be achieved when business volume is seasonally depressed, thus improving user experience, as well as setting high goals during periods when the greatest business volume and/or profitability can be expected. Thus, the system greatly increases the likelihood that year-end goals will be achieved compared to simple year-over-year percentage goal setting.

To help elucidate this approach, consider the example where a service professional needs to average $2000 per week in revenue to achieve the year-end revenue goal. If that person took off a week, as for vacation or an illness, the lost income will need to be made up to meet the year-end goal. A simplistic approach might spread the required increase evenly over the remaining weeks in the year, such as by setting a goal to make an additional $200 per week over ten weeks. However, it may be more difficult for the service professional to earn an additional $200 in some weeks, such as weeks that are typically very busy all day and thus will already have near maximum incomes (such as during prom season). To accommodate this variability, the weighting function applied to each week in setting make-up goals will vary depending upon the annual variability in the business model.

To generate the business model characteristic equation, for each class of input parameters listed in FIGS. 8A and 9, the system software performs a correlation analysis of each sub-parameter to revenue, i.e., correlating changes in revenue to changes in each sub-parameter, step 250. For clarity, examples of business parameters include revenue, margin, gross income from service-class, etc. and examples of sub-parameters include service-class as a whole, or service-class components e.g., walk-in, referral clients, repeat clients, salon clients, etc. The degree of co-relatedness (i.e., the degree to which a change in a sub-parameter correlates to a change in revenue) is used to rank the components for the order in which they will be applied in the subsequent regression analysis, step 252. For example, consider the strong correlations of Client-Class and weak Time-Class components vs. revenue follow this order. The multi-dimensional regression is thus skewed toward the parameters with strongest correlations by class and by class components (e.g., walk-in, referral clients, repeat clients, salon clients). If the correlation between a parameter and revenue is weak, its predicted value for next week can be determined by a heuristic algorithm.

These correlation tests for services, hours-worked, revenue-per-client may be repeated, step 254. Performing the correlations iteratively reduces errors. In all characteristic equations, there may be outliers in the λ-sets. By repeating the correlations, additional sensitivity data can be fed into the correlation analysis to develop characteristic equations with reduced errors. Using the rank ordered parameters a multivariant analysis of the past and current business data for the individual service professional is then performed. The output of the regression analyses may be organized in terms of five main classes: clients, services, revenue, expense, and time and a larger number of class components such as illustrated in FIGS. 8A and 9. In the illustrated embodiment there are 17 class-components including the 14 components (e.g., walk-in, HW, SHBF, Total Service $, etc.) shown in FIG. 8A and the three additional groups of components, Weekly Other Income, Commission and Professional Expenses, shown in FIG. 9. The FIG. 9 parameters are modeled differently from the 14 shown in FIG. 8A to reduce the parameter space. This enables the method to check for stability in the data and rank parameters in terms of effect on the business before formulating the characteristic equation coefficients for each term, i.e., each data entry parameter. In the linear curve fitting case, these coefficients relate to line slopes, axis intercepts, correlation coefficients, and standard deviations. In the polynomial curve fitting cases, the meaning of the coefficients is harder to define in classical terms. Regression analysis provides rough estimates for each parameter. However the next set of algorithms must be applied to refine the goals before the numbers in FIG. 8A, are posted. These goals are the projections for next week's performance.

The server 10 may be configured to use learning algorithms to determine weighted coefficients based on performance from previous year and data from the current year, step 258. In an embodiment the system software uses four learning methods (multi-dimensional-regression techniques described above plus three other methods). Learning algorithms reduce the computation burden of the system. So rather than deploying the full formulation of equation [3] every time, the system software can rely on comparative analysis with learned behavior from these three algorithms.

The first order of learning is determining the characteristic equations described by Equation [3] current year. This provides a rich set of λ-coefficients. The λ-coefficients by themselves do not tell the whole performance—especially when considered across multiple years. The algorithms apply neural nets, statistical and heuristic techniques to create “learning-coefficients” about the stylist's business model. In every multi-dimensional optimization space, there may be multiple optimum points (maxima and minima).

The application of these algorithms is partly real-time and post-processing. For example, Neural Nets are used for classification and ordering functions of current and past-year's data. Classification refers to matching the user to a cohort which is a grouping of businesses that are expected to have similar characteristics. As a first level of classification users may be classified into cohort groups based upon revenue. For example, users may be classified based upon their projected year-end revenues in terms of groupings such as $20,000-$29,999, $30,000-$45,000, $45,001-$89,999, $90,000-$120,000, etc. Individual's whose yearly income is $20,000 are likely to have business models very different from those whose yearly income is $90,000 or more. For example, those in lower income groups are more likely to be part time, inexperienced and dependent on walk-in clients compared to those in higher income groups who are more likely to be full-time with an established clientele. However, income level alone is insufficient to accurately classify businesses into like-performing groups as income levels also vary from region-to-region across the country. For example, a professional in a $60,000 cohort in Los Angeles is likely to have a different business pattern than a person making $60,000 in Columbus, Ohio due to cost of living differences. Businesses may also be classified in terms of other business data or characteristics. For example, individuals whose business is dominated by walk-in and salon appointments will be very different from those whose business is dominated by appointment and repeat business clientele. Any of a variety of business measures and related information (e.g., zip code) may be used by neural network analysis to properly classify the user's business.

The training algorithm of the Neural Network is computationally expensive. In the various embodiments the neural networks use regression analysis to learn the characteristic equation from scratch. It pre-supposes that equation [3] does not exist and performs independent multi-dimensional regressions to determine the weighting λ-coefficients of the characteristic equation. The error between the derived equation and that from the characteristic-equation [3] creates one or several optimal points for the shooter. The shooter algorithm projects the year-end results based upon the results that come out of the regression and neural network analyses, and then determines which of various projections is most likely. Then it goes back one more time to adjust what the next week needs to be to achieve the year-end goal. In sum, the shooter algorithm determines the year-end result using each of the candidate characteristic equations, determines the most likely outcome, and finally, using this result, it goes back and recalculates the weekly performance goals required to meet the year-end goal. The “optimal points” are the candidates for the end point year-end revenue projection. An end point is made up of a year-end revenue projection number and an equation describing the pattern of business performance that gets the user to that year-end number.

Using neural network analyses, the system will try to determine constantly the degree to which one (or several) learning methods are “most” appropriate. Neural network analyses are also used to determine the implicit learning rate of the system. The training algorithm has an intrinsic speed for learning. If the learning rate is not sufficient for the analysis, and thus will take too long to be useful to a service professional accessing the system on a remote computer, the system may emphasis faster algorithms, such as time-varying statistical analysis, in order to meet system performance requirements.

Another learning system is time-varying statistical learning. To a first order, the system calculates statistical performance of every parameter variation from week-to-week and across years. For example, using the previous year business data the system can quickly calculate the mean, standard deviation, variance, etc. for the user's walk-in clients, salon clients, etc. Six core statistical parameters are used in a non-dispersion analysis. In other words, the statistical parameters are determined locally (i.e., in time) and then are moved forward in time. However, this analysis may hide critical pattern data, so the system calculates statistical difference parameters across contiguous weeks to determine the sensitivities of the characteristic equations. Statistical analyses may be performed on each performance parameter within the current year, such as walk-in clients, to obtain a first dimensional statistical analysis result (e.g., mean and standard deviation of weekly walk-in revenues in the current year), and for same week within prior year business data (e.g., the mean and standard deviation of weekly walk-in revenues for week X in current and prior years).

A more detailed illustration of the calculations and processes used to generate the business model are illustrated in FIGS. 7A and 7B. FIG. 7A illustrates some of the processes involved in the first step illustrated in FIG. 6. The analysis may begin by accessing the characteristic equation and weighting-coefficients determined from the prior year's business data for the service professional, step 240. The characteristic equation and weighting-coefficients may be recalled from memory or may be recalculated. To recalculate the prior year business model, a multi-dimensional multi-variant regression analysis is performed on the prior year data, step 703. As discussed above, this regression analysis may be performed iteratively to arrive at an estimate of the characteristic equation. Next, a neural network analysis may be performed on the prior year data in order to classify and order the service professionals business model characteristic equation, step 704. The steps of classifying and ordering are function of the neural network analyses. The ordering of the coefficients fed into the shooter algorithm greatly affects its accuracy. Time-varying statistical analysis is also performed on the prior year data in order to obtain another estimate of the characteristic equation, step 705. Finally, a heuristic algorithm may be implemented in order to dynamically classify the characteristic equation, step 706.

The algorithms implemented in steps 703, 704, 705, 706 are selectively and collectively applied to derive characteristic equations and learning coefficients from previous year data. These algorithms are also used to calculate and determine coefficients and equations for the current year and to estimate the year-end revenues for the current year, step 708. The analysis engines may be tightly coupled and the specific order in which they are applied to data may be data-dependent. For typical data the multi-dimensional multi-variant regression analysis uses non-linear methods. In linear regression, assuming that the data are well-behaved within a given epoch, the classical method is based on the least-squares method. When the regression function is non-linear (e.g., exponential), the shooter algorithm takes over to perform differential analyses of velocity parameters. This iterative method in the shooter algorithm uses the predictor-corrector method or regression. Velocity parameters also reveal inflectional characteristics in the data. Such behaviors may be the result of missing data, and in some cases, the equations may appear to have singularities; e.g., when the service professional's work style is very erratic.

As part of determining coefficients and equations for the current year and to estimate the year-end revenues for the current year, step 708, the shooter algorithm may use velocity parameters obtained from the multi-dimensional multi-variant regression analysis, step 703, to estimate the equations and check the characteristic equation for stability, step 710. The use of velocity parameters in this manner is novel. This method is coupled into the shooter to derive the characteristic equation quickly. The system performs differential analysis to determine the velocity parameters (i.e., instantaneous rates of change vs. time or vs. other sub-parameters). The velocity parameters are then used as an adjunct to the multi-dimensional multi-variant analysis to define the trajectories locally. In some cases, if there is a strong correlation with previous year, the shooter algorithm will take over the projection. As part of this step, smoothing functions may be applied to the data, step 712, to address inconsistencies, such as gaps, and discontinuities in the business data, such as one-time business expenses. Results from the smoothing functions, step 712, and the shooter algorithm analysis of equation stability, step 710, are fed back to the shooting algorithm in order to enable it to better derived key characteristic equation, step 708.

Once the characteristic equation is derived, it is used to calculate current year results which can be used in a difference analysis comparing current year data to prior year business model predictions, step 714. Also, the analysis may substituted end points and current week numbers into the current year characteristic equation to determine the difference or an error of the prediction from the shooting algorithm compared to the expected year-over-year growth (YoYGr), step 716. Also, a correlation and comparison between current year characteristic equation coefficients may be compared to the coefficient matrix learned from the previous year data, step 718. This correlation is part of the time-varying statistical processing. If the correlation is strong, the previous year business model provides a good basis for the current year. The system does this analysis “along the way” and also after the current year business model characteristic equation is formulated. Results of these analyses are used in a decision and ranking analysis, step 720. In this analysis, the characteristic equation coefficients which are most strongly correlated with the business results are identified and extracted. Also, the magnitudes of the errors in the formulations of the characteristic equations are defined for the current year and compared with previous years using the ranks variables. Also, a minimum reduced equation set of coefficients may be defined. This analysis thus identifies the business factors which have the greatest impact on the overall performance of the service professional's business.

At this point, the analysis determines whether there is a reasonable correlation between current year data and predictions from the business model based on prior year data, step 722. As part of this assessment, the analysis determines whether there is a strong correlation between the weighting coefficients of the prior year business model and current year results. Also, errors between the current year data and the predictions by the prior year business model are compared to determine whether the errors are within acceptable thresholds. Additionally, the year-end growth estimation based on current year data is tested against the year-end goal to determine whether it is within an acceptable threshold. Finally, the analysis determines whether the values predicted by the characteristic equation are within a tolerance threshold. The formulation of the characteristic equation goes through a formal/final verification procedure. The heuristic engine takes over for this step and verifies the components of the characteristic equation; coefficients, equations, errors, etc. This final step uses independent sets of criteria to determine which components need re-optimization.

If the results of these assessments in step 722 are affirmative, indicating that there is a strong correlation between the prior year business model and the current year performance data, the prior year business model is used as a basis for formulating the current year characteristic equation which defines the dynamic business model for the service professional, steps 724. In this step, the results from the shooting algorithm derivation of the characteristic equation from and estimate of year-end results for the current year obtained in step 708 are used to formulate the current year characteristic equation. The current year characteristic equation is then used to generate the business goals for the service professional for the next week, step 726. The current year characteristic equation may also be used to generate business-improving coaching advice and metrics for displaying to the user, step 728.

However, if the result of the assessments in step 722 are negative, indicating that there is a weak correlation between the estimates from the prior year business model and the current year performance data, the current year characteristic equation must be deprived anew with reduced reliance upon the prior-year business model. Such a situation may arise when the characteristics of the service professional's business change, such as when there is a change in the client mix or services offered by the professional. Even when the characteristic equation for the current year is to be developed primarily on current year data, information in the prior year business model will nevertheless be used in the process. Therefore, the analysis may determine the degree of non-correlation between current year data and estimations from the prior year business model, steps 732 (see FIG. 7B). As part of this step, the analysis may apply a back-off algorithm to correct and rebalance the current year characteristic equation. Depending on the degree of non-correlation, the current year equations may exhibit offsets and errors that are systemic. In this case, it may be necessary to back-off (i.e., use less-aggressive) initial values used by the shooter and other sub-algorithms. Using these results, the process may then select a new set of year-end projection (i.e., and points) when the results indicate that there are multiple maxima and minimal inflection points. When the characteristic equation indicates multiple minima, maxima or inflections, the shooter algorithm determines which to use or whether to ignore the artifacts. If the errors are too large in the end, the system may use previously discarded coefficients. Also, neural network analysis, step 704, Time-varying statistical analysis, step 705, and heuristic analyses, step 706, may be performed to reclassify or change the classification assigned to the service professionals business, step 734. Alternatively, the characteristic equation may be reformulated with new error thresholds.

Using the results from step 734, the method can then determine whether the weighting-coefficient in the reformulated business model is strongly correlated to the current year data, steps 736. As part of this assessment, the analysis determines whether there is a strong correlation between the weighting coefficients of the reformulated business model and current year results. Also, errors between the current year data and the predictions by the prior year business model are compared to determine whether the errors are within acceptable thresholds. Additionally, the year-end growth estimation based on current year data is tested against the year-end goal to determine whether it is within an acceptable threshold. Finally, the analysis determines whether the values predicted by the characteristic equation are within a tolerance threshold. It should be noted that the analyses conducted in step 736, while similar to the analyses conducted in step 722, are conducted in view of insights obtained from the analyses conducted in steps 732, 734. More particularly, the analyses conducted in step 722 focus on formulating the current year characteristic equation while attempting to correlate it to the prior year's business model. In steps 732 and 734 the analysis determines the degree to which the current year business model correlates to the prior year. If there is low correlation, the analyses in step 736 are performed depending more strongly on current year data and relying weekly on the prior year business model.

If the results of these assessments in step 736 are affirmative, indicating that there is a strong correlation between the reformulated business model and the current year performance data, the reformulated business model is used as a basis for formulating the current year characteristic equation by returning to step 720 described above with reference to FIG. 7A to perform the decision and ranking process. The reformulated business model will then be used as the basis for formulating the current year characteristic equation, step 724, which is then used to generate the business goals for the next week, step 726.

However, if there is a weak correlation between the weighting-coefficients in the reformulated business model and the current year data (i.e., the result of tests in step 736 are “No”), the process may continue in a learning process to discover the new characteristic equation appropriate for the current year. A first step in this process involves reapplying the current year on reduced shooting variables determined in step 720. At this point, the business model characteristic equation may be a mostly good fit to current year business data. The system may now try to optimize regions of poor fit to business data Sometimes, the coefficients-sets may show unexplained anomalies (not necessarily discontinuities). This process continues in a self-learning module based upon the current year data with only a weak dependence upon the prior year characteristic equation, step 742. In this learning mode, the analysis generates an expanded set of learning characteristic equation coefficients, step 744. In doing so it uses the real business data instead of the algorithm-generated business model parameters in order to optimize the multi-dimensional multi-variant regression analysis. This regression analysis is performed iteratively in order to settle on a characteristic equation with minimal residuals. As part of this iterative process, tentative results, particularly velocity parameters, may be used by the shooter algorithm to determine the characteristic equation stability, step 710. Also as part of this process, a neural network engine may be trained on current “new” data to generate new classification thresholds, step 746. The additional training is necessary when the coefficient space is expanded. The previously generated classifications may need to be changed to accommodate the new coefficient space.

Output from the expanded set of learning characteristic equation coefficients are correlated and current year coefficients of the learning matrix are compared to the characteristic equation coefficients of the classification cohort group, step 748. Up to this point the analyses have operated on the business data of the individual service professional. At this step 748 the performance of the professional's business is compared to cohort businesses. In an embodiment, the insights and patterns that can be inferred from cohort business models may be incorporated in many of the analyses of the professional's business data even before this step 748. Results from this analysis are then used to formulate the current year characteristic equation, step 750. In this phase, the system is operating on individual stylist data as compared with cohort data. The formulated current year characteristic equation is then used to classify the business to identify the appropriate cohort, and the current year business model is calibrated against the cohort characteristic equation, step 752. If there are differences, here minimization functions may be applied, step 754, and the classification comparison re-performed, step 752, in an iterative manner. Finally, when the current year business model is settled, it is used to generate the business goals for next week, step 726, and for generating business improvement coaching advice, step 728.

In the foregoing analyses, information available from the cohort group of other businesses may be used to help derive the service professional's characteristic equation, step 708, and calibrate the current year business model to the cohort, step 752. In particular, the characteristic equations and weighting λ-coefficients for the cohort group may be obtained and compared to the current year business model being developed. This information regarding the cohort characteristic equation are obtained off-line (i.e., not at the time the service professional is interacting with the server) as the analyses involved are computationally expensive. To develop the cohort characteristic equation the processes illustrated in step 780 shown in FIG. 7C can be performed. Using business information within the cohort group, the analysis can utilize MDMVR, step 703, neural network analysis, step 704, time-varying statistical analysis, step 705, and heuristic analysis, step 706 to create a learning matrix for the cohort group, step 762. Then the analysis can utilize neural network analysis, step 704, time-varying statistical analysis, step 705, and heuristic analysis, step 706 to build a cohort business model classification, step 764. Results of this analysis are then stored so that they can be accessed, such as while deriving the characteristic equation, step 708, or calibrating the current year business model to the cohort, step 752.

The analyses described are performed each week in order to re-extract a new set of characteristic equations and coefficients using the latest week's business data. The process then correlates the business models generated from week 1 through the current week and applies error-minimization functions, step 754. A heuristic engine monitors the business model performance with the analysis engines describe above with reference to steps 703, 704, 705, and 706.

Calculations involved in the multi-dimensional multi-variant regression analyses are illustrated by the following example. The following example equation assumes that it is the fifth week of the current year. The server 10 calculates the solutions for the λₙ “coefficients.” In some cases the calculation also includes a residue function ε calculation denoted by equation [4].

$$[ \begin{matrix}{C}_{W 1} \\ {C}_{W 2} \\ {C}_{W 3} \\ {C}_{W 4} \\ {C}_{W 5}\end{matrix} ] ≡ [ \begin{matrix}W {I}_{11} & R F {C}_{12} & R P {C}_{13} & S {C}_{14} \\ W {I}_{21} & R F {C}_{22} & & \\ W {I}_{31} & R F {C}_{32} & & \\ W {I}_{41} & R F {C}_{42} & & \\ W {I}_{51} & R F {C}_{52} & & \end{matrix} ] [ \begin{matrix}{λ}_{W 1} \\ {λ}_{W 2} \\ {λ}_{W 3} \\ {λ}_{W 4} \\ {λ}_{W 5}\end{matrix} ] + [ \begin{matrix}{ɛ}_{w 1} \\ {ɛ}_{w 2} \\ {ɛ}_{w 3} \\ {ɛ}_{w 4} \\ {ɛ}_{w 5}\end{matrix} ] \qquad [ 4 ]$$

This matrix in equation [4] can be large since it can contain up to 52 weeks worth of data. Its solution is a closed form if the residue terms are zero. The server 10 can use an iterative search method to find the λₙ coefficients. The solution method depends on the characteristics of the data. If the matrix is sparse, as is common, the system software can use LU decomposition methods.

Equation [4] describes performance in terms of past data. To determine goal calculations for week 6 based on 5 weeks of data, the server 10 may be configured to use equation [3] to scale the λₙ coefficients. At this point, the server 10 has enough data to estimate the goals for the next week step 258. However, the server 10 can also perform additional analysis to compare and calibrate the data for the current week versus data for previous weeks and data for previous years. This is done to check the stability and accuracy of the goal for the next week.

If the stylist has performance data for the previous year, the server 10 can also calculate the λₙ coefficients for the previous year(s). This creates a λₙ coefficient tree that holds the performance memory of the system. The λₙ coefficients are unique for each week. For example, the set of values for Year 2007-Week 30 is different from the set of values for Year 2007-Week 31.

$$2007 \{ \underbrace{\begin{matrix}{Week}_{1} & {Week}_{2} & {Week}_{3} & … \\ {λ}_{w 1} & {λ}_{w 21} & {λ}_{w 31} & \\ & {λ}_{w 22} & {λ}_{w 32} & \\ & & {λ}_{w 33} & \\ & & & \end{matrix}}_{Walk \text{-} i n} , \\ 2007 \{ \underbrace{\begin{matrix}{Week}_{1} & {Week}_{2} & {Week}_{3} & … \\ {λ}_{w 1} & {λ}_{w 21} & {λ}_{w 31} & \\ & {λ}_{w 22} & {λ}_{w 32} & \\ & & {λ}_{w 33} & \\ & & & \end{matrix}}_{R F C} , etc … \qquad [ 5 ]$$

The number of λₙ coefficients always matches the week number. Also, as shown, the λₙ coefficient sets are always unique for each week. The server 10 may extend this formulation to services, hours-worked and service dollars.

Having accomplished these steps, the server 10 can now determine the service professional's current business model, step 260. This business model reflects the unique signature of business parameters and their relative weights (e.g., impact on revenue) that defines the service professional's performance in real-time. The business model discovery process described above determines how the goals for the client can be predicted. An example is provided in Table 1 below. The server 10 can use about 21 data items for the signatures that define each business model. In the examples shown in Table 1, business models for two salon stylists appear to be very similar, but their clientele class components are different. These differences account for large variations in longitudinal performance. One business may grow more predictably with less effort than the other.

TABLE 1
Example of Business Models

| Clients | | | | | Services | | | Revenue | | | | | Use of Time | |
|---|---|---|---|---|---|---|---|---|---|---|---|---|---|---|
| WI | RFC | RPC | SC | PB | SHBF | CHEM | CWBN | Gross | Net | Gratuity | Margin | Avg. Ticket | HW/wk | Clients/HW |
| 0% | 50% | 25% | 25% | 80% | 20% | 20% | 60% | $60K | $40K | 15% | 80% | $75 | 40 | 1.1 |
| 75% | 0% | 0% | 25% | 10% | 20% | 20% | 60% | $60K | $40K | 15% | 80% | $75 | 40 | 1.1 |

The server 10 can also be configured to use a slicing function that is partly heuristic and partly neural net-based for classification. For example, the client class (i.e., walk-in (WI), referral clients (RFC), repeat clients (RPC), salon clients (SC)) may contain the quad-tuplet {WI, RFC, RPC, SC} and the predicted values for a number of clients may be 16. If a 25% slicer (i.e., the unit number of clients=4) is used, there would exist 5 possibilities for each variable; i.e., {0%, 25%, 50%, 75%, 100%}. Technically, the number of discrete quad-tuplets=5⁽⁴⁻¹⁾=625. However, there are only 35 valid quad-tuplets. For example, {WI, RFC, RPC, SC}={100%, 0%, 0%, 0%} ∥ {0%, 50%, 50%, 0%}, etc, are all valid quad-tuplets. However {WI, RFC, RPC, SC}={100%, 100%, 0%, 0%} ∥ {0%, 50%, 75%, 0%}, etc, are not valid quad-tuplets because they produce client-sums exceeding 16.

As shown in the two bizMod examples in Table 1, the two salon stylists have similar business revenue but their clientele are very differently.

The system software can also compute time-series sensitivities to determine how the business model varies from week to week throughout the year. This analysis extends the business model matrix by adding velocity (i.e., parameter changes vs. time) parameters, step 262. In traditional finance, velocity=revenue/investment. The various embodiments use a physical definition of velocity: the instantaneous rate of change of a parameter with respect to a time-epoch (1 week). The parameter may be a primary parameter, such as “revenue-per-week,” or may be a derived parameter, such as “revenue-per-client-per-week.” Velocity parameters are important in the analyses performed in the various embodiment methods. Velocity parameters are implicitly used to derive best-fit equations for data sets and λ-coefficients. Velocity parameters are explicitly used to determine how the shooter models yearly performance. For example, in a situation where the business data is best modeled by a linear characteristic equation, by calculating the velocity parameters for the previous year, with correcting parameters obtained from the learning algorithms, the velocity parameter will determine how the equation for the current year's estimate should look. The velocity parameters determine minima and maxima and help to speed up the basic learning algorithm.

The server 10 may also be configured to search the time series for discontinuities from week to week in a given business model, step 264. Such discontinuities may be a result of business cycles, such as occur in the hair styling business around certain holidays and during certain seasons, and of volatility within a particular business. For example in the second example business model shown in Table 1, the clientele of the second model is expected to have exhibit instability from week to week. This is because the raw data shows a client mix comprising 75% walk-in and 10%pre-booked clients (PB). The over-reliance on walk-in, which typically are unpredictable and variable, means that the revenue/client changes drastically from week to week; i.e., it is unstable.

With these analyses completed, a services professional's goals can be verified against the stability thresholds, step 266. A stability threshold is set by the respective velocity parameter. The higher the velocity, the more unstable a business model appears. Stability is related to velocity. For example, Table 1 shows two business models which have roughly the same number of working hours, revenue, tip revenue, etc. However, the businesses have very different client mixes. A chart of week-to-week performance of these two users will be very different, as the user with predominantly walk-in and salon clients will show large variability in revenues compared to the user whose clients are predominately appointment and repeat clients. Thus, the second user will have a high revenue velocity week to week. If the revenue velocity exceeds a threshold, the business is termed unstable. Also, a business with high velocity may yield a characteristic equation that is basically unstable in that the coefficients determined from one week to the next may change significantly. If walk-in client generated revenues change from 2 per-week (very normal for a stylist with good business model) to 15 per-week (typical for a stylist with over-reliance on walk-in clients), the walk-in-velocity is 13. The stability threshold is an index graduated in 30% increments (this parameter is heuristically corrected for each stylist-revenue-cohort). The stability threshold measures±changes around the characteristic equation of the current year. The business model is determined to be unstable if the velocity parameters are large and exhibit sign changes.

The server 10 may also use λₙ coefficient formulations as mined parameters for the given service professional and the corresponding cohort, i.e., the group of other similarly situated service professionals. Mining refers to using information (e.g., coefficients of characteristic equations) obtained from data records of other service professionals stored within the system. By building up a database of many service professionals, characteristic business patterns and typical performance results can be mined from the group of similar businesses to learn characteristics of the cohort group that can be used as a basis of comparison. Such mined information can be used to generate a characteristic equation for the cohort. Mining can also provide means, standard deviation, variance, and other statistical parameters for the cohort characteristic equation. Every parameter used in the characteristic equation will be statistically analyzed, so that, for example, the cohort may include an average, standard deviation and variance for walk-in clients, salon clients, appointment clients, etc. In this embodiment, the server 10 accesses the λₙ coefficients calculated for other cohort service professionals within the database to determine an average or representative set of λₙ coefficients for a cohort characteristic equation. The cohort characteristic equation then can be used to compare the service professional's business model defined by the currently determined λₙ coefficient to those of the prior year and/or those of an average cohort, step 268. Since business models may vary from city to city and state to state, the mining of λₙ coefficients may be limited to particular service professionals within a selected geographic region. For example, for a particular zip code, the server 10 can analyze clusters of similar business models to provide baseline coaching to any one of the service professionals. In this manner, a service professional can be provided with national, regional and local peer comparisons. For example, costs of living in New York or Los Angeles are generally higher than in Des Moines, Iowa. Thus the system uses national and other variances to either normalize data within a revenue-cohort or, create new stylist-cohorts.

The metrics obtained from the cohort business model feed the shooting algorithm with sensitivity data to help calibrate the projection calculations. In this manner, the shooting algorithm can evaluate various projections based upon how closely they follow the business patterns, performance and statistical characteristics of the corresponding cohort business model.

The heuristic learning component is less mathematically rigorous, using rules or table-based look up rules. This system determines time-based patterns, such as triangle wave, sinusoidal, linear patterns, which most closely match a set of data. For example, a λ-coefficient may be oscillatory for some weeks, linear for others, and in some weeks it may have discontinuities. The heuristic pattern search is used in projecting the correct short-term equations to use as the basis for the learning. Thus, if the heuristic analysis recognizes that the first few weeks in the current year are described by a sinusoidal wave pattern, the analysis may select a sinusoid equation to be used in the regression analysis for that period of time. Further, heuristic analysis is used as a sanity-checking system that evaluates the outputs of the application of neural nets and statistical methods. Heuristic analyses also offer fault-detection; e.g., by recognized when a stylist in a revenue-cohort performs significantly differently from the cohort.

The system is designed to learn new information and how it deviates from the baseline. The question of whether “existing cohort classifications need to be changed based on new data” is performed by heuristics. When the system learns new data, the system can apply external information, such as recognizing that the user should be classified in a different cohort. The system may also define new performance classifications as the population of users shift en-mass or within individual cohort.

The embodiment system software can provide coaching guidance to a service professional aimed at keeping the individual's business within the profile of their established business model. The outputs of regression and fitting calculations ensure that growth is skewed toward the parameters with strongest correlation to revenue. Thus, the weighted coefficients can be used to identify high leverage adjustments that can be made to keep the business on track to meet goals, step 270. However, if the analysis strongly suggests a growth in walk-ins compared to historical performance, the system software can provide suggestions to the services professional to adjust the growth to more stable client classes. Again, the forcing functions may be derived from mined data of the individual stylist's performance and the zip code cohorts. These calculations may be used to generate real-time reports which can be used to track the growth and optimize the performance of the service professional's business.

In another embodiment, the server 10 may also be configured to provide business performance coaching to a service professional, step 272. Business performance coaching may include suggestions aimed at achieving goals and stability. The server 10 uses the superset of reduced parameters, such as those listed in the table 803 shown in FIG. 8B which are those parameters which the analyses have identified as having the most impact on the business. To avoid distracting the user, coaching suggestions may be limited to the two or three parameters which have the greatest impact on business performance. This embodiment includes further backend processing and is not done in real-time.

In a preferred embodiment polynomial curve fitting and/or function fitting regression analyses are used to determine time varying trends and patterns. Most businesses are cyclical, and thus are best modeled by a polynomial-based business model. Such a polynomial business model can best reflect the ups and downs in businesses such as hair styling which occur throughout the year, particularly around holidays and during certain seasons. As the dataset grows, the regression analysis will be better able to fit a polynomial business model to the data and thus better anticipate when such patterns occur. The polynomial business model can then be used to build growth models that realistically mirror the business cycles of the service professional's business and market.

There are about 110 dynamic parameters that fall out of the longitudinal analyses detailed above. For example, these dynamic parameters include: Velocity parameters (walk-in vs. Week, Weighted Expense vs. Week, Time-per-client vs. Week), Statistical variance of primary and velocity parameters vs. time, neural net classification variables, ordering parameters for λₙ-coefficients, heuristic tracking parameters and shooting parameters. Other velocity parameters measure performance variables vs. others vs. time. The server 10 may be configured to use a ranking algorithm to determine a small subset of focus areas for each service professional. For example, if the service professional's velocity calculations show large discontinuities, step 264, such as evidenced by reliance on walk-in clients, the coaching algorithm may rank clientele change very high, thus indicating that changing the client mix will have the greatest impact on the professional's business performance. Also, if the service professional's referrals rate is low, this area may be ranked high. In contrast, if the analysis shows margin performance significantly below that of the relevant cohort (or industry), step 268, margin improvement techniques may be suggested. Margin improvement suggestions may include reducing required business expenses (RbEx). For sustained business expansion, the service professional must continue to add new clients every week. Mining results within the database of historical business data can reveal a wide array of inhibitors to sustained growth.

In an exemplary embodiment, coaching may be done with live personnel and on a one-on-one basis as the “RSSS Advanced Coaching System” (RACS). In this embodiment, users can subscribe to RACS to access the server 10 and receive one-on-one review and coaching from a team of experts worldwide. RACS adds the human analysis dimension that is difficult to teach a computer program. Over time, the embodiment systems will learn many of these metrics as its internal neural engines learn correlations.

RACS is beneficial because it provides one-on-one coaching from a consultant who understands all aspects of the relevant business, such as hair styling. A coach may be someone who knows the service professional's neighborhood and local business environment. Such one-on-one advice may provide valuable insight and help the salon professional to optimize time, plan to reduce hours and maximize services.

In another embodiment, the system utilizes two novel business referral systems. “Refer a friend” and “Give a Gift.” The system software may implement a referral system to enable service professionals to refer their colleagues to the system. From the “Your Account” page (FIG. 14), a user may refer a friend by supplying their email and other contact information. Once submitted, the server emails an invitation with encrypted links to the referred party. The system software also tracks the referral in the user's “Your Account” page. When the referred party signs on and begins subscription, the user may receive a full or partial credit equivalent to one subscription-month. User may refer friends at any time. The system software may continue to waive subscription dues as long as there are referral credits. The system software may also allow referrals to be self-initiated. In this case, the referred party will not receive an email from the system. Similarly, the system software may include a “Give a Gift” system which allows registered users to purchase usage credits as gifts for friends. In such an implementation the system software will notify the recipient and credit their account appropriately.

In an embodiment the system includes a custom ecommerce module that implements a subscription-based billing system. The ecommerce module controls user-registration and monthly subscriptions. This module may be a custom implementation that is designed to track and account for the unique way in which the system software operates. This module may control access based on monthly billing which occurs on the first day of the month. This module may also register purchases of “Give a Gift” or other stylist development products.

Examples of webpages that may be generated by the server 10 in the implementation of the various embodiments are illustrated in FIGS. 8A through 15.

The hardware used to implement the foregoing embodiments may be processing elements and memory elements configured to execute a set of instructions, wherein the set of instructions are for performing method steps corresponding to the above methods. Alternatively, some steps or methods may be performed by circuitry that is specific to a given function.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile handset are intended to encompass any one or all memory modules within the mobile handset without limitation to a particular configuration, type or packaging. An exemplary storage medium is coupled to a processor in either the mobile handset or the theme server such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

1. A method for tracking business performance of a service professional, comprising:
receiving in a server business parameter data provided by the service professional;
storing the received business parameter data in a database;
performing a multivariate regression analysis on the business parameter data to identify a plurality of coefficients defining a characteristic equation of the service professional's business;
applying the received business parameter data to the characteristic equation of the service professional's business to generate a performance measure of the service professional's business; and
generating a report including the performance measure.

2. The method of claim 1, further comprising:
comparing the characteristic equation of the service professional's business to a cohort model derived from other business models stored in the database; and
generating a report based upon the comparison.

3. The method of claim 1, further comprising:
applying the received business parameter data to a cohort model derived from other business models stored in the database to generate a performance measure of the cohort model; and
refining the characteristic equation of the service professional's business based upon results of applying the received business parameter data to a cohort model.

4. The method of claim 1, further comprising:
applying neural network analysis to the received business parameter data; and
refining the characteristic equation for the service professional's business based upon the results of the neural network analysis.

5. The method of claim 4, further comprising:
applying time-varying statistical analysis to the received business parameter data; and
refining the characteristic equation for the service professional's business based upon the results of the time-varying statistical analysis.

6. The method of claim 4, further comprising:
applying a heuristic analysis to the received business parameter data, the results of the multivariate regression analysis, the results of the neural network analysis and the time-varying statistical analysis; and
refining the characteristic equation for the service professional's business based upon the results of the heuristic analysis.

7. The method of claim 1, further comprising:
comparing predictions from prior year business model to the received business parameter data to determine a degree of correlation; and
incorporating the prior year business model as an input to the generation of the characteristic equation of the service professional's business depending upon the degree of correlation.

8. The method of claim 1, wherein the service professional is a hair salon professional and the business parameter data include parameters relevant to a hair salon service business.

9. The method of claim 1, further comprising:
performing a correlation analysis of business parameter data to rank business parameters in order of their correlation to business revenues; and
performing the multivariate regression analysis based on the rank order.

10. The method of claim 1, wherein the generated performance measure of the service professional's business comprises a projection of the business's performance in a subsequent week.

11. The method of claim 10, further comprising:
comparing the projection of the business's performance in a subsequent week to a goal; and
generating a report providing business goals for the subsequent week.

12. The method of claim 1, further comprising:
identifying business parameters which have greatest impact on business revenues; and
generating a report advising the service professional on actions that can be taken to improve business performance based on the business parameters with greatest impact on business revenues.

13. The method of claim 1, wherein the business parameter data include data for walk-in clients, referral clients, repeat clients, and salon clients.

14. A server, comprising:
a processor;
a memory coupled to the processor; and
a network interface circuit coupled to the processor configured to enable the processor to communicate with an internetwork,
the processor configured with processor-executable software instructions to perform steps comprising:
receiving in a server business parameter data provided by the service professional;
storing the received business parameter data in a database;
performing a multivariate regression analysis on the business parameter data to identify a plurality of coefficients defining a characteristic equation of the service professional's business;
applying the received business parameter data to the characteristic equation of the service professional's business to generate a performance measure of the service professional's business; and
generating a report including the performance measure.

15. The server of claim 14, wherein the processor is configured with processor-executable software instruction to perform further steps comprising:
comparing the characteristic equation of the service professional's business to a cohort model derived from other business models stored in the database; and
generating a report based upon the comparison.

16. The server of claim 14, wherein the processor is configured with processor-executable software instruction to perform further steps comprising:
applying the received business parameter data to a cohort model derived from other business models stored in the database to generate a performance measure of the cohort model; and
refining the characteristic equation of the service professional's business based upon results of applying the received business parameter data to a cohort model.

17. The server of claim 14, wherein the processor is configured with processor-executable software instruction to perform further steps comprising:
applying neural network analysis to the received business parameter data; and
refining the characteristic equation for the service professional's business based upon the results of the neural network analysis.

18. The server of claim 17, wherein the processor is configured with processor-executable software instruction to perform further steps comprising:
applying time-varying statistical analysis to the received business parameter data; and
refining the characteristic equation for the service professional's business based upon the results of the time-varying statistical analysis.

19. The server of claim 17, wherein the processor is configured with processor-executable software instruction to perform further steps comprising:
applying a heuristic analysis to the received business parameter data, the results of the multivariate regression analysis, the results of the neural network analysis and the time-varying statistical analysis; and
refining the characteristic equation for the service professional's business based upon the results of the heuristic analysis.

20. The server of claim 14, wherein the processor is configured with processor-executable software instruction to perform further steps comprising:
comparing predictions from prior year business model to the received business parameter data to determine a degree of correlation; and
incorporating the prior year business model as an input to the generation of the characteristic equation of the service professional's business depending upon the degree of correlation.

21. The server of claim 14, wherein the service professional is a hair salon professional and the business parameter data include parameters relevant to a hair salon service business.

22. The server of claim 14, wherein the processor is configured with processor-executable software instruction to perform further steps comprising:
performing a correlation analysis of business parameter data to rank business parameters in order of their correlation to business revenues; and
performing the multivariate regression analysis based on the rank order.

23. The server of claim 14, wherein the generated performance measure of the service professional's business comprises a projection of the business's performance in a subsequent week.

24. The server of claim 14, wherein the processor is configured with processor-executable software instruction to perform further steps comprising:
comparing the projection of the business's performance in a subsequent week to a goal; and
generating a report providing business goals for the subsequent week.

25. The server of claim 14, wherein the processor is configured with processor-executable software instruction to perform further steps comprising:
identifying business parameters which have greatest impact on business revenues; and
generating a report advising the service professional on actions that can be taken to improve business performance based on the business parameters with greatest impact on business revenues.

26. The server of claim 14, wherein the business parameter data include data for walk-in clients, referral clients, repeat clients, and salon clients.
